(19) United States
(12) Patent Application Publication
(10) Pub. No.: US 2026/0003242 A1
(43) Pub. Date: Jan. 1, 2026

(54) A VARIABLE LIGHT TRANSMISSION DEVICE COMPRISING MICROCELLS

(71) Applicant: E INK CORPORATION, Billerica, MA (US)

(72) Inventors: Bryan DUNN, Medford, MA (US); Pavel KAMAEV, Lexington, MA (US); Karl Raymond AMUNDSON, Cambridge, MA (US); Yu XIA, Acton, MA (US)

(21) Appl. No.: 19/244,352

(22) Filed: Jun. 20, 2025

Related U.S. Application Data
(60) Provisional application No. 63/664,243, filed on Jun. 26, 2024.

(51) Int. Cl. G02F 1/1676; G02F 1/1681; G02F 1/1685

(52) U.S. Cl. CPC G02F 1/1676; G02F 1/1681; G02F 1/1685; G02F 2203/01

(57) ABSTRACT

A variable light transmission device is disclosed that mitigates negative aperture diffraction effects and shows good switching speed between the open and the closed optical states. The device comprises a microcell layer disposed between two light transmissive electrode layers, the microcell layer having a plurality of microcells, each microcell including an electrophoretic medium. And each microcell comprises a protrusion structure and a channel.

### RELATED APPLICATION

This application claims priority to U.S. Provisional Patent Application No. 63/664,243 filed on Jun. 26, 2024, which is incorporated by reference in its entirety, along with all other patents and patent applications disclosed herein.

### BACKGROUND OF THE INVENTION

This invention relates to a variable light transmission device. Specifically, the invention relates to a microcell electro-optic device comprising an electrophoretic medium comprising electrically charged pigment particles and a non-polar liquid. The electrophoretic medium can switch between optical states using electric fields. The variable light transmission device can modulate the amount of light and other electromagnetic radiation passing through them. It can be used on mirrors, windows, sunroofs, and similar items. For example, the present invention may be applied on windows that can modulate light that enters buildings and vehicles. Examples of electrophoretic media that may be incorporated into various embodiments of the present invention include, for example, the electrophoretic media described in U.S. Pat. Nos. 7,116,466, 7,327,511, 8,576,476, 10,319,314, 10,809,590, 10,067,398, 10,067,398, and 11,143,930, and U.S. Patent Application Publication Nos. 2014/0055841, 2017/0351155, 2017/0235206, 2011/0199671, 2020/0355979, 2020/0272017, 2021/0096439, and U.S. patent application Ser. No. 17/953,386, filed on Sep. 27, 2022, the contents of which are incorporated by reference herein in their entireties.

Particle-based electrophoretic displays, in which a plurality of electrically charged pigment particles move through a suspending fluid under the influence of an electric field, have been the subject of intense research and development for a number of years. Such displays can have attributes of good brightness and contrast, wide viewing angles, state bistability, and low power consumption when compared with liquid crystal displays.

The terms “bistable” and “bistability” are used herein in their conventional meaning in the art to refer to displays comprising display elements having first and second display states differing in at least one optical property, and such that after any given element has been driven by means of an addressing pulse of finite duration, to assume either its first or second display state, after the addressing pulse has terminated, that state will persist for at least several times, for example at least four times, the minimum duration of the addressing pulse required to change the state of the display element. It is shown in published U.S. Patent Application Ser. No. 2002/0180687 that some particle-based electrophoretic displays capable of gray scale are stable not only in their extreme black and white states but also in their intermediate gray states, and the same is true of some other types of electro-optic displays. This type of display is properly called “multi-stable” rather than bistable, although for convenience the term “bistable” may be used herein to cover both bistable and multi-stable displays.

As noted above, electrophoretic media require the presence of a suspending fluid. In most prior art electrophoretic media, this suspending fluid is a liquid, but electrophoretic media can be produced using gaseous suspending fluids. Such gas-based electrophoretic media appear to be susceptible to the same types of problems due to particle settling as liquid-based electrophoretic media, when the media are used in an orientation which permits such settling, for example in a sign where the medium is disposed in a vertical plane. Indeed, particle settling appears to be a more serious problem in gas-based electrophoretic media than in liquid-based ones, since the lower viscosity of gaseous suspending fluids as compared with liquid ones allows more rapid settling of the electrically charged pigment particles.

Numerous patents and applications assigned to or in the names of the Massachusetts Institute of Technology (MIT), E Ink Corporation, E Ink California, LLC, and related companies describe various technologies used in encapsulated and microcell electrophoretic and other electro-optic media. Encapsulated electrophoretic media comprise numerous small capsules, each of which comprises an internal phase containing electrophoretically-mobile particles in a liquid medium, and a capsule wall surrounding the internal phase. Typically, the capsules are themselves held within a polymeric binder to form a coherent layer positioned between two electrodes. In a microcell electrophoretic display, the electrically charged pigment particles and the liquid are not encapsulated within microcapsules but instead are retained within a plurality of cavities formed within a carrier medium, typically a polymeric film. The technologies described in these patents and applications include:
(a) Electrophoretic particles, fluids and fluid additives; see for example U.S. Pat. Nos. 5,961,804; 6,017,584; 6,120,588; 6,120,839; 6,262,706; 6,262,833; 6,300,932; 6,323,989; 6,377,387; 6,515,649; 6,538,801; 6,580,545; 6,652,075; 6,693,620; 6,721,083; 6,727,881; 6,822,782; 6,831,771; 6,870,661; 6,927,892; 6,956,690; 6,958,849; 7,002,728; 7,038,655; 7,052,766; 7,110,162; 7,113,323; 7,141,688; 7,142,351; 7,170,670; 7,226,550; 7,230,750; 7,230,751; 7,236,290; 7,277,218; 7,286,279; 7,312,916; 7,382,514; 7,390,901; 7,473,782; 7,561,324; 7,583,251; 7,572,394; 7,576,904; 7,580,180; 7,679,814; 7,848,006; 7,903,319; 8,018,640; 8,115,729; 8,257,614; 8,270,064; 8,363,306; 8,390,918; 8,582,196; 8,654,436; 8,902,491; 8,961,831; 9,052,564; 9,341,915; 9,348,193; 9,361,836; 9,366,935; 9,372,380; 9,382,427; 9,423,666; 9,428,649; 9,557,623; 9,670,367; 9,671,667; 9,688,859; 9,726,957; 9,752,034; 9,765,015; 9,778,535; 9,778,537; 9,835,926; 9,953,588; 9,995,987; 10,025,157; 10,031,394; 10,040,954; 10,061,123; 10,062,337; 10,147,366; and 10,514,583; and U.S. Patent Application Publication Nos. 2003/0048522; 2003/0151029; 2003/0164480; 2004/0030125; 2004/0105036; 2005/0012980; 2009/0009852; 2011/0217639; 2012/0049125; 2013/0161565; 2013/0193385; 2013/0244149; 2013/0063333; 2014/0011913; 2014/0078576; 2014/0104674; 2014/0231728; 2015/0177590; 2015/0185509; 2015/0241754; 2015/0301425; and 2016/0170106;
(b) Capsules, binders and encapsulation processes; see for example U.S. Pat. Nos. 5,930,026; 6,067,185; 6,130,774; 6,262,706; 6,327,072; 6,392,786; 6,459,418; 6,727,881, 6,839,158; 6,866,760; 6,922,276; 6,958,848; 6,987,603; 7,110,164; 7,148,128; 7,184,197; 7,304,634; 7,327,511, 7,339,715; 7,411,719; 7,477,444; 7,561,324; 7,910,175; 7,952,790; 8,129,655; 8,446,664; and U.S. Patent Applications Publication Nos. 2005/0156340; 2007/0091417; and 2009/0122389;
(c) Microcell structures, wall materials, and methods of forming microcells; see for example U.S. Pat. Nos. 6,672,921; 6,751,007; 6,753,067; 6,781,745; 6,788,452; 6,795,229; 6,806,995; 6,829,078; 6,850,355; 6,865,012; 6,870,662; 6,885,495; 6,930,818; 6,933,098; 6,947,202; 7,046,228; 7,072,095; 7,079,303; 7,141,279; 7,156,945; 7,205,355; 7,233,429; 7,261,920; 7,271,947; 7,304,780; 7,307,778; 7,327,346; 7,347,957; 7,470,386; 7,504,050; 7,580,180; 7,715,087; 7,767,126; 7,880,958; 8,002,948; 8,154,790; 8,169,690; 8,441,432; 8,891,156; 9,279,906; 9,291,872; 9,388,307; 9,436,057; 9,436,058; 9,470,917; 9,919,553; and 10,401,668; and U.S. Patent Applications Publication Nos. 2003/0203101; 2014/0050814; and 2016/0059442;
(d) Methods for filling and sealing microcells; see for example U.S. Pat. Nos. 6,545,797; 6,788,449; 6,831,770; 6,833,943; 6,930,818; 7,046,228; 7,052,571; 7,166,182; 7,347,957; 7,374,634; 7,385,751; 7,408,696; 7,557,981; 7,560,004; 7,564,614; 7,572,491; 7,616,374; 7,715,087; 7,715,088; 8,361,356; 8,625,188; 8,830,561; 9,346,987; and 9,759,978; and U.S. Patent Applications Publication Nos. 2002/0188053; 2004/0120024; 2004/0219306; and 2015/0098124;
(e) Films and sub-assemblies containing electro-optic materials; see for example U.S. Pat. Nos. 6,825,829; 6,982,178; 7,110,164; 7,158,282; 7,554,712; 7,561,324; 7,649,666; 7,728,811; 7,826,129; 7,839,564; 7,843,621; 7,843,624; 7,952,790; 8,034,209; 8,177,942; 8,390,301; 9,238,340; 9,470,950; 9,835,925; and U.S. Patent Applications Publication Nos. 2005/0122563; 2007/0237962; and 2011/0164301;
(f) Backplanes, adhesive layers and other auxiliary layers and methods used in displays; see for example U.S. Pat. Nos. D485,294; 5,930,026; 6,120,588; 6,124,851; 6,177,921; 6,232,950; 6,252,564; 6,312,304; 6,312,971; 6,376,828; 6,392,786; 6,413,790; 6,480,182; 6,498,114; 6,506,438; 6,518,949; 6,545,291; 6,639,578; 6,657,772; 6,664,944; 6,683,333; 6,710,540; 6,724,519; 6,816,147; 6,819,471; 6,825,068; 6,831,769; 6,842,279; 6,842,657; 6,865,010; 6,873,452; 6,909,532; 6,967,640; 7,012,600; 7,012,735; 7,030,412; 7,075,703; 7,106,296; 7,110,163; 7,116,318; 7,148,128; 7,167,155; 7,173,752; 7,176,880; 7,190,008; 7,206,119; 7,223,672; 7,230,751; 7,256,766; 7,259,744; 7,301,693; 7,304,780; 7,327,346; 7,327,511; 7,347,957; 7,365,733; 7,388,572; 7,401,758; 7,492,497; 7,535,624; 7,551,346; 7,554,712; 7,560,004; 7,583,427; 7,649,674; 7,667,886; 7,672,040; 7,688,497; 7,826,129; 7,830,592; 7,839,564; 7,880,958; 7,893,435; 7,905,977; 7,952,790; 7,986,450; 8,034,209; 8,049,947; 8,072,675; 8,120,836; 8,159,636; 8,177,942; 8,237,892; 8,362,488; 8,395,836; 8,437,069; 8,441,414; 8,456,589; 8,514,168; 8,547,628; 8,576,162; 8,610,988; 8,714,780; 8,743,077; 8,754,859; 8,797,258; 8,797,633; 8,797,636; 9,147,364; 9,025,234; 9,025,238; 9,030,374; 9,140,952; 9,201,279; 9,223,164; 9,238,340; 9,285,648; 9,454,057; 9,529,240; 9,620,066; 9,632,373; 9,666,142; 9,671,635; 9,715,155; 9,777,201; 9,897,891; 10,037,735; 10,190,743; 10,324,577; 10,365,533; 10,372,008; 10,446,585; 10,466,565; 10,495,941; 10,503,041; 10,509,294; 10,613,407; and U.S. Patent Applications Publication Nos. 2002/0060321; 2004/0085619; 2004/0105036; 2005/0122306; 2005/0122563; 2006/0255322; 2009/0122389; 2010/0177396; 2011/0164301; 2011/0292319; 2014/0192000; 2014/0210701; 2014/0368753; and 2016/0077375; and International Application Publication Nos. WO2000/038000; WO2000/005704; and WO1999/067678;
(g) Color formation and color adjustment; see for example U.S. Pat. Nos. 6,017,584; 6,545,797; 6,664,944; 6,788,452; 6,864,875; 6,914,714; 6,972,893; 7,038,656; 7,038,670; 7,046,228; 7,052,571; 7,075,502; 7,167,155; 7,385,751; 7,492,505; 7,667,684; 7,684,108; 7,791,789; 7,800,813; 7,821,702; 7,839,564; 7,910,175; 7,952,790; 7,956,841; 7,982,941; 8,040,594; 8,054,526; 8,098,418; 8,159,636; 8,213,076; 8,363,299; 8,422,116; 8,441,714; 8,441,716; 8,466,852; 8,503,063; 8,576,470; 8,576,475; 8,593,721; 8,605,354; 8,649,084; 8,670,174; 8,704,756; 8,717,664; 8,786,935; 8,797,634; 8,810,899; 8,830,559; 8,873,129; 8,902,153; 8,902,491; 8,917,439; 8,964,282; 9,013,783; 9,116,412; 9,146,439; 9,164,207; 9,170,467; 9,170,468; 9,182,646; 9,195,111; 9,199,441; 9,268,191; 9,285,649; 9,293,511; 9,341,916; 9,360,733; 9,361,836; 9,383,623; and 9,423,666; and U.S. Patent Applications Publication Nos. 2008/0043318; 2008/0048970; 2009/0225398; 2010/0156780; 2011/0043543; 2012/0326957; 2013/0242378; 2013/0278995; 2014/0055840; 2014/0078576; 2014/0340430; 2014/0340736; 2014/0362213; 2015/0103394; 2015/0118390; 2015/0124345; 2015/0198858; 2015/0234250; 2015/0268531; 2015/0301246; 2016/0011484; 2016/0026062; 2016/0048054; 2016/0116816; 2016/0116818; and 2016/0140909;
(h) Methods for driving displays; see for example U.S. Pat. Nos. 5,930,026; 6,445,489; 6,504,524; 6,512,354; 6,531,997; 6,753,999; 6,825,970; 6,900,851; 6,995,550; 7,012,600; 7,023,420; 7,034,783; 7,061,166; 7,061,662; 7,116,466; 7,119,772; 7,177,066; 7,193,625; 7,202,847; 7,242,514; 7,259,744; 7,304,787; 7,312,794; 7,327,511; 7,408,699; 7,453,445; 7,492,339; 7,528,822; 7,545,358; 7,583,251; 7,602,374; 7,612,760; 7,679,599; 7,679,813; 7,683,606; 7,688,297; 7,729,039; 7,733,311; 7,733,335; 7,787,169; 7,859,742; 7,952,557; 7,956,841; 7,982,479; 7,999,787; 8,077,141; 8,125,501; 8,139,050; 8,174,490; 8,243,013; 8,274,472; 8,289,250; 8,300,006; 8,305,341; 8,314,784; 8,373,649; 8,384,658; 8,456,414; 8,462,102; 8,514,168; 8,537,105; 8,558,783; 8,558,785; 8,558,786; 8,558,855; 8,576,164; 8,576,259; 8,593,396; 8,605,032; 8,643,595; 8,665,206; 8,681,191; 8,730,153; 8,810,525; 8,928,562; 8,928,641; 8,976,444; 9,013,394; 9,019,197; 9,019,198; 9,019,318; 9,082,352; 9,171,508; 9,218,773; 9,224,338; 9,224,342; 9,224,344; 9,230,492; 9,251,736; 9,262,973; 9,269,311; 9,299,294; 9,373,289; 9,390,066; 9,390,661; and 9,412,314; and U.S. Patent Applications Publication Nos. 2003/0102858; 2004/0246562; 2005/0253777; 2007/0091418; 2007/0103427; 2007/0176912; 2008/0024429; 2008/0024482; 2008/0136774; 2008/0291129; 2008/0303780; 2009/0174651; 2009/0195568; 2009/0322721; 2010/0194733; 2010/0194789; 2010/0220121; 2010/0265561; 2010/0283804; 2011/0063314; 2011/0175875; 2011/0193840; 2011/0193841; 2011/0199671; 2011/0221740; 2012/0001957; 2012/0098740; 2013/0063333; 2013/0194250; 2013/0249782; 2013/0321278; 2014/0009817; 2014/0085355; 2014/0204012; 2014/0218277; 2014/0240210; 2014/0240373; 2014/0253425; 2014/0292830; 2014/0293398; 2014/0333685; 2014/0340734; 2015/0070744; 2015/0097877; 2015/0109283; 2015/0213749; 2015/0213765; 2015/0221257; 2015/0262255; 2015/0262551; 2016/0071465; 2016/0078820; 2016/0093253; 2016/0140910; and 2016/0180777;
(i) Applications of displays; see for example U.S. Pat. Nos. 6,118,426; 6,473,072; 6,704,133; 6,710,540; 6,738,050; 6,825,829; 7,030,854; 7,119,759; 7,312,784; 7,705,824; 8,009,348; 8,011,592; 8,064,962; 8,162,212; 8,553,012; 8,973,837; 9,188,829; and 9,197,704; and U.S. Patent Applications Publication Nos. 2002/0090980; 2004/0119681; 2007/0285385; 2013/0176288; 2013/0221112; 2013/0233930; 2013/0235536; 2014/0049808; 2014/0062391; 2014/0206292; and 2016/0035291; and International Application Publication No. WO 00/36560; and
(j) Non-electrophoretic displays, as described in U.S. Pat. Nos. 6,241,921; 6,784,953; 6,795,138; 6,914,713; 6,950,220; 7,095,477; 7,182,830; 7,245,414; 7,420,549; 7,471,369; 7,576,904; 7,580,180; 7,850,867; 8,018,643; 8,023,071; 8,282,762; 8,319,759; and 8,994,705 and U.S. Patent Applications Publication Nos. 2005/0099575; 2006/0262249; 2007/0042135; 2007/0153360; 2008/0020007; 2012/0293858; and 2015/0277160; and applications of encapsulation and microcell technology other than displays; see for example U.S. Pat. No. 7,615,325; and U.S. Patent Application Publications Nos. 2015/0005720 and 2016/0012710.

Many of the aforementioned patents and applications recognize that the wall surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of a non-polar liquid and a continuous phase of a polymeric material, and that the discrete droplets of electrophoretic medium within such a polymer-dispersed electrophoretic display may be regarded as capsules or microcapsules even though no discrete capsule membrane is associated with each individual droplet; see for example, the aforementioned 2002/0131147. Accordingly, for purposes of the present application, such polymer-dispersed electrophoretic media are regarded as sub-species of encapsulated electrophoretic media.

A related type of electrophoretic display is a so-called “microcell electrophoretic display”. In a microcell electrophoretic display, the electrically charged pigment particles and the suspending liquid are not encapsulated within microcapsules but instead are retained within a plurality of cavities formed within a carrier medium, typically a polymeric film. See, for example, International Application Publication No. WO 02/01281, and published U.S. application Ser. No. 2002/0075556, both assigned to Sipix Imaging, Inc.

Although electrophoretic media are often opaque (since, for example, in many electrophoretic media, the particles substantially block transmission of visible light through the display) and operate in a reflective mode, many electrophoretic displays can be made to operate in a so-called “shutter mode” in which one display state is substantially opaque and one is light-transmissive. See, for example, U.S. Pat. Nos. 6,130,774 and 6,172,798, and 5,872,552; 6,144,361; 6,271,823; 6,225,971; and 6,184,856. Dielectrophoretic displays, which are similar to electrophoretic displays but rely upon variations in electric field strength, can operate in a similar mode; see U.S. Pat. No. 4,418,346. Other types of electro-optic displays may also be capable of operating in shutter mode.

An encapsulated or microcell electrophoretic display typically does not suffer from the clustering and settling failure mode of traditional electrophoretic devices and provides further advantages, such as the ability to print or coat the display on a wide variety of flexible and rigid substrates. Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition; and other similar techniques. Thus, the resulting display can be flexible. Further, because the display medium can be printed using a variety of methods, the display itself can be made inexpensively.

One potentially important market for electrophoretic media is windows with variable light transmission. As the energy performance of buildings and vehicles becomes increasingly important, electrophoretic media could be used as coatings on windows to enable the proportion of incident radiation transmitted through the windows to be electronically controlled by varying the optical state of the electrophoretic media. Effective implementation of such “variable transmissivity” (“VT”) technology in buildings is expected to provide (1) reduction of unwanted heating effects during hot weather, thus reducing the amount of energy needed for cooling, the size of air conditioning plants, and peak electricity demand; (2) increased use of natural daylight, thus reducing energy used for lighting and peak electricity demand; and (3) increased occupant comfort by increasing both thermal and visual comfort. Even greater benefits would be expected to accrue in an automobile, where the ratio of glazed surface to enclosed volume is significantly larger than in a typical building. Specifically, effective implementation of VT technology in automobiles is expected to provide not only the aforementioned benefits but also (1) increased motoring safety, (2) reduced glare, (3) enhanced mirror performance (by using an electro-optic coating on the mirror), and (4) increased ability to use heads-up displays. Other potential applications of VT technology include privacy glass and glare-guards in electronic devices.

The art provides examples of devices comprising electrophoretic media, which is encapsulated in microcells and sandwiched by electrode layers that are able to achieve a closed optical state (opaque state) and an open optical state (transparent state) and to switch between these states by application of electric fields across the electrophoretic medium. However, conventional electrophoretic devices using conventional structures require long switching times. An important reason for the slow switching between optical states of variable light transmission devices is less than optimal structures of the interior of the microcell, resulting in fluid flows that do not effectively and efficiently position the electrophoretic particles in the microcell surface near the first light transmissive electrode layer to produce the close optical state. The inventors of the present invention unexpectedly found that devices comprising microcells having specific architecture achieve efficient switching between the open and close optical states.

### SUMMARY OF THE INVENTION

In one aspect, the present invention provides a variable light transmission device (200) comprising a first light transmissive electrode layer (202), a second light transmissive electrode layer (207), and a microcell layer (203). The microcell layer (203) is disposed between the first light transmissive electrode layer (202) and the second light transmissive electrode layer (207). The microcell layer (203) comprises a plurality of microcells (204) and a sealing layer (206). Each microcell of the plurality of microcells (204) includes an electrophoretic medium (209), the electrophoretic medium (209) comprising electrically charged pigment particles (223) and a non-polar liquid. Each microcell of the plurality of microcells (204) has a microcell opening (205), the sealing layer (206) spanning the microcell openings (205) of the plurality of microcells (204). The sealing layer (206) of each microcell has an upper surface and a lower surface. The lower surface is in contact with the electrophoretic medium (209). The upper surface is in contact (i) with the first light transmissive electrode layer (202) or (ii) with an adhesive layer, the adhesive layer being disposed between the first light transmissive electrode layer (202) and the upper surface of the sealing layer (206). Each microcell of the plurality of microcells (204) comprises a microcell bottom layer (210), a protrusion structure (217), a microcell wall (212), and a channel (215). The microcell bottom layer (210) has a microcell bottom inside surface (211), the microcell bottom inside surface (211) comprising an exposed microcell bottom inside surface (211a) and an unexposed microcell bottom inside surface (211b).

The protrusion structure (217) has a protrusion side surface (221), a protrusion base (218), a protrusion apex (219), a protrusion height (220), and, optionally, a protrusion structure well (217b) in which case the protrusion structure (217) is a combination of a solid part of the protrusion structure (217a) and the protrusion structure well (217b). The protrusion structure well (217b) has a volume that is filled with electrophoretic medium (209). The protrusion structure well has a three-dimensional shape consisting of one geometric solid or a combination of two or more geometric solids. The one geometric solid and each geometric solid of the combination of two or more geometric solids of the three-dimensional shape of the protrusion structure well (217b) are selected from the group consisting of a cone, a concave cone, a convex cone, a conical frustum, a concave conical frustum, a concave conical frustum, and a cylinder. The cone, the concave cone, and the convex cone have a base, an apex, and a slope. The conical frustum has a large base, a small base, and a slope. The concave conical frustum and the convex conical frustum have a large base, a small base, a first slope, and a second slope. The cylinder has a first base and a second base. The protrusion side surface, in the case where the protrusion structure has a protrusion structure well (217b), is a surface of the solid part of the protrusion structure (217a), not including the protrusion apex (219), that is in contact with the electrophoretic medium (209). The protrusion side surface consists of a protrusion inside surface (222b) and a protrusion outside surface (222a). The protrusion inside surface (222b) is in contact with the protrusion structure well (217b). The protrusion outside surface (222a) is the protrusion side surface without the protrusion inside surface (222b). The protrusion side surface (221), in the case where the protrusion structure (217) does not have a protrusion structure well, is a surface of the protrusion structure (217), not including the protrusion apex, that is in contact with the electrophoretic medium (209). The protrusion base (218) is a surface of the protrusion structure that is in contact with the microcell bottom inside surface (211). As mentioned above, in the case that the protrusion structure (217) has a protrusion structure well (217b), the protrusion structure (217) consists of the solid part of the protrusion structure (217a) and the protrusion structure well (217b). The protrusion apex (219) is a point or a set of points of the protrusion structure (217) having shorter distance from the microcell opening (205) than all other points of the protrusion structure (217). The protrusion height (220) is the distance between the protrusion base (218) and the protrusion apex (219). The protrusion structure well (217b) has a protrusion structure well base (218b), the protrusion structure well base (218b) being a surface of the three-dimensional shape of the protrusion structure well (217b) that is in contact with the microcell bottom inside surface (211). The protrusion structure well (217b) is a three-dimensional shape that is defined by a space between (i) a plane that is parallel to the plane of the protrusion base (218) and includes the protrusion apex (219), (ii) the protrusion inside surface (222b), and (iii) the microcell bottom inside surface (211).

The microcell wall (212) has a microcell inside wall surface (213) and a microcell wall upper surface (214). The microcell inside wall surface (213) is a surface of the microcell wall (212) that is in contact with the electrophoretic medium (209). The microcell wall upper surface (214) is a surface of the microcell wall (212) that is in contact with the sealing layer (206).

The channel (215) has a channel height (216h), a channel base, a channel base width, an inner base perimeter (224), and an outer base perimeter (225). The channel height (216h) is 50% of the protrusion height (220). The inner base perimeter (224) is the intersection of the microcell wall (212) and the exposed microcell bottom inside surface (211a). The outer base perimeter (225) is the intersection of the protrusion base and the exposed microcell bottom inside surface (211a). The channel base width (216w) is the smallest distance between a point in the inner base perimeter (224) of the channel (215) and a point in the outer base perimeter (225) of the channel (215). In the case where the protrusion structure (217) does not have a protrusion structure well (217b), the channel (215) is a volume that is defined by (i) the exposed microcell bottom inside surface (211a), (ii) the microcell wall inside surface (213), (iii) a plane that is parallel to the microcell bottom inside surface (211), the plane having a distance from the microcell bottom inside surface (211) equal to the channel height (216h), and (iv) the protrusion side surface (221). In the case where the protrusion structure (217) has a protrusion structure well (217b), the channel (215) is a three-dimensional shape that is defined by a space between (i) the exposed microcell bottom inside surface (211a), (ii) the microcell wall inside surface (213), (iii) a plane that is parallel to the microcell bottom inside surface (211), the plane having a distance from the microcell bottom inside surface (211) equal to the channel height (216h), and (iv) the protrusion outside surface (222a). The channel (215) comprises a first edge (226) and a second edge (227). The first edge (226) is formed by the microcell wall inside surface (213) and the microcell bottom inside surface (211). The second edge (227) is formed by the microcell bottom inside surface (211) and the protrusion side surface (221). The first edge (226), the second edge (227), or both the first edge (226) and the second edge (227) are filleted.

Application of a first electric field via a first waveform between the first light transmissive electrode layer (202) and the second light transmissive electrode layer (207) of the variable light transmission device the protrusion structure of which does not have a protrusion structure well, causes movement of the electrically charged pigment particles (223) towards the channel (215). Application of a first electric field via a first waveform between the first light transmissive electrode layer (202) and the second light transmissive electrode layer (207) of the variable light transmission device the protrusion structure of which has a protrusion structure well, cause movement of the electrically charged pigment particles (223) towards the channel (215) and the protrusion structure well (217b), resulting in switching of the variable light transmission device (200) to an open optical state. Application of a second electric field via a second waveform between the first light transmissive electrode layer (202) and the second light transmissive electrode layer (207) causes a movement of the electrically charged pigment particles (223) towards the first light transmissive electrode layer (202), wherein the closed optical state has lower percent transparency than the open optical state. The movement of the electrically charged pigment particles (223) towards the first light transmissive electrode layer (202) caused by application of the second electric field may have a velocity, the velocity having a lateral component. The second waveform may comprise at least one positive voltage and at least one negative voltage, the second waveform having a net positive or net negative impulse. The second waveform may comprise an AC waveform, the AC waveform having a duty cycle of from 5% to 45%. The second waveform may comprise a DC-offset waveform, which is formed by a superposition of a DC voltage component and an AC waveform.

The variable light transmission device of the present invention may comprise (i) an adhesive layer, the adhesive layer being disposed between the first light transmissive electrode layer (202) and the sealing layer (206), (ii) a second adhesive layer, the second adhesive layer being disposed between the microcell layer (203) and the second light transmissive electrode layer (207), or (iii) both the adhesive layer and the second adhesive layer.

The electrically charged pigment particles (223) of the electrophoretic medium of the variable light transmission device of the present invention may be light absorbing.

The variable light transmission device of the present invention may comprise a light blocking layer (230) disposed between the microcell wall upper surface (214) and the sealing layer (206); the light blocking layer (230) may be conductive; the light blocking layer (230) may comprise light absorbing pigment; the light absorbing pigment of the light blocking layer (230) may have black color.

In the case of a variable light transmission device, where the protrusion structure (217) does not have a protrusion structure well, the protrusion structure (217) may be a three-dimensional shape consisting of one geometric solid or a combination of two or more geometric solids. The one geometric solid and each geometric solid of the combination of the two or more geometric solids of the three-dimensional shape of the protrusion structure (217) may be selected from the group consisting of a cone, a concave cone, a conical frustum, a concave conical frustum, a convex conical frustum, and a cylinder. The cone and the concave cone have a base, an apex, and a slope. The conical frustum has a large base, a small base, and a slope. The concave conical frustum and the convex conical frustum have a large base, a small base, a first slope, and a second slope. The cylinder has a first base and a second base.

In the case of a variable light transmission device where the protrusion structure (217) does not have a protrusion structure well and the three-dimensional shape of the protrusion structure (217) consists of one geometric solid, the one geometric solid may be a cone or a concave cone, the apex of the cone or concave cone being the protrusion apex (219), and the base of the cone or concave cone being the protrusion base (218).

In the case of a variable light transmission device where the protrusion structure (217) does not have a protrusion structure well and the three-dimensional shape of the protrusion structure (217) consists of two, three, or four geometric solids, the protrusion structure (217) may be, respectively, a first geometric solid on a second geometric solid, a first geometric solid on a second geometric solid on a third geometric solid, or a first geometric solid on a second geometric solid on a third geometric solid on a fourth geometric solid, the first geometric solid comprising the protrusion apex (219), the first geometric solid being a cone or a concave cone, and the apex of the cone or concave cone being the protrusion apex (219).

In the case of a variable light transmission device where the protrusion structure (217) does not have a protrusion structure well, the three-dimensional shape of the protrusion structure (217) may be (a) a concave cone on a cylinder, the first base of the cylinder being the protrusion base (218), the second base of the cylinder being in contact with the base of the concave cone, and the apex of the concave cone being the protrusion apex (219); (b) a cone on a conical frustum, the large base of the conical frustum being the protrusion base (218), the small base of the conical frustum being in contact with the base of the cone, the apex of the cone being the protrusion apex (219), and the slope of the cone being larger than the slope of the conical frustum; (c) a concave cone on a conical frustum, the large base of the conical frustum being the protrusion base (218), the small base of the conical frustum being in contact with the base of the concave cone, and the apex of the concave cone being the protrusion apex (219); (d) a cone or a concave cone on a concave conical frustum, the large base of the concave conical frustum being the protrusion base (218), the small base of the concave conical frustum being in contact with the base of the cone or concave cone, the apex of the cone or concave cone being the protrusion apex (219); (e) a cone or a concave cone on a convex conical frustum, the large base of the convex conical frustum being the protrusion base (218), the small base of the convex conical frustum being in contact with the base of the cone or concave cone, and the apex of the cone or concave cone being the protrusion apex (219); (f) a cone or a concave cone on a convex conical frustum on a conical frustum, the large base of the conical frustum being the protrusion base (218), the small base of the conical frustum being in contact with the large base of the convex conical frustum, the small base of the convex conical frustum being in contact with the base of the cone or concave cone, the apex of the cone or concave being the protrusion apex (219), and the slope of the cone being larger than the second slope of the convex conical frustum; (g) a cone or a concave cone on a convex conical frustum on a concave conical frustum, the large base of the concave conical frustum being the protrusion base (218), the small base of the concave conical frustum being in contact with the large base of the convex conical frustum, the small base of the convex conical frustum being in contact with the base of the cone or concave cone, and the apex of the cone or concave cone being the protrusion apex (219); (h) a cone on a first conical frustum on a second conical frustum, the large base of the second conical frustum being the protrusion base (218), the small base of the second conical frustum being in contact with the large base of the first conical frustum, the small base of the first conical frustum being in contact with the base of the cone, the apex of the cone being the protrusion apex (219), and the slope of the first conical frustum being smaller than the slope of the cone; (i) a concave cone on a first conical frustum on a second conical frustum, the large base of the second conical frustum being the protrusion base (218), the small base of the second conical frustum being in contact with the large base of the first conical frustum, the small base of the first conical frustum being in contact with the base of the concave cone, and the apex of the concave cone being the protrusion apex (219); (j) a cone on a conical frustum on a concave conical frustum, the large base of the concave conical frustum being the protrusion base (218), the small base of the concave conical frustum being in contact with the large base of the conical frustum, the small base of the conical frustum being in contact with the base of the cone, the apex of the cone being the protrusion apex (219), and the slope of the conical frustum being smaller than the slope of the cone; (k) a cone or a concave cone on a concave conical frustum on a convex conical frustum, the large base of the convex conical frustum being the protrusion base (218), the small base of the convex conical frustum being in contact with the large base of the concave conical frustum, the small base of the concave conical frustum being in contact with the base of the cone or the concave cone, and the cone apex or the concave cone apex being the protrusion apex (219); (l) a cone on a conical frustum on a concave conical frustum, the large base of the concave conical frustum being the protrusion base (218), the small base of the concave conical frustum being in contact with the large base of the conical frustum, the small base of the conical frustum being in contact with the base of the cone, the apex of the cone being the protrusion apex (219), and the slope of the cone being larger than the slope of the conical frustum; (m) a concave cone on a conical frustum on a concave conical frustum, the large base of the concave conical frustum being the protrusion base (218), the small base of the concave conical frustum being in contact with the large base of the conical frustum, the small base of the conical frustum being in contact with the base of the concave cone, and the apex of the concave cone being the protrusion apex (219); (n) a cone or a concave cone on a convex conical frustum on a concave conical frustum on a conical frustum, the large base of the conical frustum being the protrusion base (218), the small base of the conical frustum being in contact with the large base of the concave conical frustum, the small base of the concave conical frustum being in contact with the large base of the concave conical frustum, the small base of the convex conical frustum being in contact with the base of the cone or concave cone, and the apex of the cone or concave cone being the protrusion apex (219); and (o) a cone or a concave cone on a convex conical frustum on a first concave conical frustum or a conical frustum, on a second concave conical frustum, the large base of the second concave conical frustum being the protrusion base (218), the small base of the second concave conical frustum being in contact with the large base of the first concave conical frustum or conical frustum, the small base of the first concave conical frustum or conical frustum being in contact with the large base of the convex conical frustum, the small base of the convex conical frustum being in contact with the base of the cone or concave cone, and the apex of the cone or concave cone being the protrusion apex (219).

In the case of a variable light transmission device where the protrusion structure (217) has a protrusion structure well, the protrusion structure well (217b) is a three-dimensional shape that may consist of one geometric solid; the one geometric solid may be a cylinder, a conical frustum, a convex conical frustum, a cone, or a convex cone; the first base of the cylinder, the large base of the conical frustum, the large base of the convex conical frustum, the base of the cone, or the base of the convex cone may be on a plane that is parallel to the microcell bottom inside surface (211) and containing the protrusion apex (219); the second base of the cylinder, the small base of the conical frustum, the small base of the convex conical frustum, the apex of the cone, or the apex of the convex cone may be in contact with the microcell bottom inside surface (211).

In the case of a variable light transmission device where the protrusion structure (217) has a protrusion structure well, the protrusion structure well (217b) is a three-dimensional shape that may consist of a combination of two geometric solids, a first geometric solid and a second geometric solid, the first geometric solid may be on the second geometric solid; the first geometric solid may be a conical frustum, a convex conical frustum, or a concave conical frustum; the second geometric solid may be a conical frustum, a convex conical frustum, a concave conical frustum, a cylinder, a cone, a concave cone, or a convex cone; the large base of the conical frustum, the large base of the convex conical frustum, or the large base of the concave conical frustum of the first geometric solid may be on a plane that is parallel to the microcell bottom inside surface (211) and containing the protrusion apex (219); the small base of the conical frustum, the small base of the convex conical frustum, or the small base of the concave conical frustum of the first geometric solid may be in contact with the large base of the conical frustum, the large base of the convex conical frustum, the large base of the concave conical frustum, the first base of the cylinder, the base of the cone, the base of the concave cone, or the base of the convex cone of the second geometric solid; the small base of the conical frustum, the small base of the convex conical frustum, the small base of the concave conical frustum, the second base of the cylinder, the apex of the cone, the apex of the concave cone, or the apex of the convex cone of the second geometric solid may be in contact with the microcell bottom inside surface (211).

In the case of a variable light transmission device where the protrusion structure (217) has a protrusion structure well (217b), the protrusion structure well (217b) is a three-dimensional shape that may consist of a combination of three geometric solids, a first geometric solid, a second geometric solid, and the third geometric solid; the first geometric solid may be on a second geometric solid, and the second geometric solid may be on a third geometric solid; the first geometric solid may be a conical frustum, a convex conical frustum, or a concave conical frustum; the second geometric solid may be a conical frustum, a convex conical frustum, or a concave conical frustum; the third geometric solid may be a conical frustum, a convex conical frustum, a concave conical frustum, a cone, a convex cone, a concave cone, or a cylinder; the large base of the conical frustum, the large base of the convex conical frustum, and the large concave conical frustum of the first geometric solid may be on a plane that is parallel to the microcell bottom inside surface (211) and containing the protrusion apex (219); the small base of the conical frustum, the small base of the convex conical frustum, or the small base of the concave conical frustum of the first geometric solid may be in contact with the large base of the conical frustum; the large base of the convex conical frustum, or the large base of the concave conical frustum of the second geometric solid; the small base of the conical frustum, the small base of the convex conical frustum, or the small base of the concave conical frustum of the second geometric solid may be in contact with the large base of the conical frustum, the large base of the convex conical frustum, the large base of the concave conical frustum, the base of the cone, the base of the convex cone, the base of the concave cone, or the large base of the cylinder of the third geometric solid; the small base of the conical frustum, the small base of the convex conical frustum, the small base of the concave conical frustum, the apex of the cone, the apex of the convex cone, the apex of the concave cone, or the second base of the cylinder of the third geometric solid may be in contact with the microcell bottom inside surface (211).

In the case of a variable light transmission device where the protrusion structure (217) has a protrusion structure well (217b), the three-dimensional shape of the protrusion structure (217) may be (a) a concave conical frustum, the large base of the concave conical frustum being the protrusion base (218) and the small base of the concave conical frustum being the protrusion apex (219); (b) a concave conical frustum on a cylinder, the first base of the cylinder being the protrusion base (218), the second base of the cylinder being in contact with the large base of the concave conical frustum, and the small base of the being the concave conical frustum being the protrusion apex (219); (c) a first conical frustum on a second conical frustum, the large base of the second conical frustum being the protrusion base (218), the small base of the second conical frustum being in contact with the large base of the first conical frustum, and the small base of the first conical frustum being the protrusion apex (219); (d) a concave conical frustum on a conical frustum, the large base of the conical frustum being the protrusion base (218), the small base of the conical frustum being in contact with the large base of the concave conical frustum, and the small base of the concave conical frustum being the protrusion apex (219); (e) a first concave conical frustum on a second concave conical frustum, the large base of the second concave conical frustum being the protrusion base (218), the small base of the second concave conical frustum being in contact with the large base of the first concave conical frustum, and the small base of the first concave conical frustum being the protrusion apex (219); (f) a conical frustum on a convex conical frustum, the large base of the convex conical frustum being the protrusion base (218), the small base of the convex conical frustum being in contact with the large base of the conical frustum, and the small base of the conical frustum being the protrusion apex (219); (g) a concave conical frustum on a convex conical frustum, the large base of the convex conical frustum being the protrusion base (218), the small base of the convex conical frustum being in contact with the large base of the concave conical frustum, and the small base of the concave conical frustum being the protrusion apex (219).

In the case of a variable light transmission device where the protrusion structure (217) has a protrusion structure well (217b), the three-dimension structure of the protrusion structure (217) may consist of a first geometric solid on a second geometric solid on a third geometric solid, wherein the first geometric solid is a conical frustum or a concave conical frustum, the second geometric solid is a conical frustum, a concave conical frustum, or a convex conical frustum, the third geometric solid is a conical frustum, a concave conical frustum, or a convex conical frustum, wherein the large base of the conical frustum, a concave conical frustum, or a convex conical frustum of the third geometric solid is the protrusion base (218), wherein the small base of the conical frustum, a concave conical frustum, or a convex conical frustum of the third geometric solid is in contact with the large base of the conical frustum, a concave conical frustum, or a convex conical frustum of the second geometric solid, wherein the small base of the conical frustum, a concave conical frustum, or a convex conical frustum of the second geometric solid is in contact with the large base of the conical frustum or the concave conical frustum of the first geometric solid, and wherein the small base of the conical frustum or the concave conical frustum of the first geometric solid is the protrusion apex (219).

Each microcell of the plurality of microcells of the variable light transmission device of the present invention may have a microcell length of from 400 micrometers to 850 micrometers, from 450 micrometers to 800 micrometers, from 500 micrometers to 750 micrometers, or from 600 micrometers to 740 micrometers. Each microcell of the plurality of microcells of the variable light transmission device of the present invention may have a microcell height of from 20 micrometers to 100 micrometers, from 20 micrometers to 90 micrometers, from 20 micrometers to 80 micrometers, from 20 micrometers to 60 micrometers, from 20 micrometers to 40 micrometers, from 30 micrometers to 90 micrometers, from 30 micrometers to 80 micrometers, from 30 micrometers to 60 micrometers, from 30 micrometers to 40 micrometers, from 40 micrometers to 80 micrometers, from 40 micrometers to 60 micrometers, from 40 micrometers to 50 micrometers, from 25 micrometers to 40 micrometers, from 50 micrometers to 100 micrometers, or from 50 micrometers to 80 micrometers.

Each microcell of the plurality of microcells of the variable light transmission device of the present invention may have a protrusion height of from 15 micrometers to 90 micrometers, from 20 micrometers to 90 micrometers, from 20 micrometers to 80 micrometers, from 20 micrometers to 70 micrometers, from 20 micrometers to 50 micrometers, from 20 micrometers to 30 micrometers, from 30 micrometers to 80 micrometers, from 30 micrometers to 70 micrometers, from 30 micrometers to 50 micrometers, from 30 micrometers to 40 micrometers, from 40 micrometers to 90 micrometers, from 40 micrometers to 50 micrometers, from 30 micrometers to 50 micrometers, from 25 micrometers to 35 micrometers, from 50 micrometers to 90 micrometers, or from 50 micrometers to 70 micrometers.

The variable light transmission device of the present invention may comprise a microcell, wherein the microcell wall inside surface (213) and the microcell bottom inside surface (211) form an angle (φ), the angle (φ) being from 90 to 120 degrees, from 90 to 110 degrees, from 90 to 100 degrees, from 92 to 120 degrees, from 92 to 110 degrees, from 92 to 100 degrees, from 95 to 120 degrees, from 95 to 110 degrees, or from 95 to 110 degrees.

### BRIEF DESCRIPTION OF DRAWINGS

FIG. 1A and FIG. 1B illustrate examples of edges that are not filleted.

FIG. 1C and FIG. 1D illustrate examples of filleted edges that correspond to not filleted examples of edges FIG. 1A and FIG. B, respectively.

FIG. 2 is an illustration of a cylindrical particle in a liquid under the influence of an applied electric field and resulting forces on the particle.

FIGS. 3A, 3B, and 3C illustrate a side view of an example of a microcell of a variable light transmission device of the first embodiment of the present invention.

FIG. 4 illustrates a top view of an example of a microcell of a variable light transmission device of the first embodiment of the present invention.

FIG. 5A illustrates a side view of an example of a protrusion structure of a variable light transmission device of the first embodiment of the present invention.

FIG. 5B illustrates a side view of a portion of a profile of a protrusion structure of a non-inventive variable light transmission device.

FIGS. 6A, 6B, 6C, 6D, 6E, 6F, 6G, and 6F illustrate side views of examples of protrusion structures of a variable light transmission device of the present invention.

FIGS. 7A, 7B, and 7C illustrate side views of an example of a microcell of a variable light transmission device of the second embodiment of the present invention.

FIG. 8 illustrates a side view of an example of a protrusion structure well of a variable light transmission device of the second embodiment of the present invention.

FIG. 9 illustrates a perspective view of an example of a microcell of a variable light transmission device of the second embodiment of the present invention.

FIG. 10A illustrates a side view of an example of a microcell of a variable light transmission device of the second embodiment of the present invention at an open optical state.

FIG. 10B illustrates a side view of an example of a microcell of a variable light transmission device of the second embodiment of the present invention at a closed optical state.

FIG. 11 is an example of a second waveform that can be applied on a variable light transmittance device of the present invention to achieve a closed optical state; this example comprises a DC-imbalanced waveform that includes an AC waveform having a duty cycle that is higher than 50%.

FIG. 12 is another example of a second waveform that can be applied on a variable light transmittance device of the present invention device to achieve a closed optical state; the waveform is a superposition of a DC voltage component and an AC waveform.

FIG. 13 illustrates a force exerted by an electrically charged pigment particle on the conical protrusion side surface of the protrusion of a variable light transmission device of the present invention.

FIG. 14 illustrates a side view of an example of a microcell of a microcell of a variable light transmission device of the second embodiment of the present invention; the microcell of this example comprises a light blocking layer on the microcell wall upper surface.

FIG. 15 illustrates a side view of an example of a microcell of a variable light transmission device of the second embodiment of the present invention; the microcell wall inside surface and the microcell bottom surface of the microcell of this example form an angle (φ), the angle (φ) being higher than 90 degrees.

FIG. 16A illustrates a side view of a portion of an example of a microcell of a control variable light transmission device showing the velocities of the electrophoretic particles in the microcell protrusion structure well.

FIG. 16B illustrates a side view of a portion of an example of a microcell of a variable light transmission device having a filleted edge that is formed by the solid part of the protrusion structure well and the microcell bottom inside surface, the drawing showing the velocities of electrophoretic particles in the microcell protrusion structure well.

FIG. 17A illustrates an example of a microcell protrusion structure having a steepled part.

FIG. 17B illustrates an example of a microcell protrusion structure that does not have a steepled part.

FIG. 18A illustrates a side view of a portion of an example of a microcell of a variable light transmission device, the solid part of which has a steepled part, the drawing showing the velocities of electrophoretic particles in the microcell protrusion structure well.

FIG. 18B illustrates a side view of a portion of an example of a microcell of a variable light transmission device, the solid part of which does not have a steepled part, the drawing showing the velocities of electrophoretic particles in the microcell protrusion structure well.

FIG. 18C illustrates a side view of a portion of an example of a microcell of a variable light transmission device, the solid part of which has a steepled part, the drawing showing fluid flows in the protrusion structure well.

FIG. 18D illustrates a side view of a portion of an example of a microcell of a variable light transmission device, the solid part of which does not have a steepled part, the drawing showing fluid flows in the protrusion structure well.

FIGS. 19A, 19B, and 19C illustrate side views of a portion of three examples of microcells of variable light transmission devices, the solid part of the protrusion structure of which have different three-dimension shapes, the drawings showing fluid flows in the protrusion structure well.

### DETAILED DESCRIPTION OF THE INVENTION

As used herein, a “variable light transmission device” is a device comprising an electrophoretic medium, wherein the quantity of transmitted light through the device can be controlled by application of an electric field across the electrophoretic medium.

The terms “electrically charged pigment particle” and “electrically charged pigment particles” are synonymous with the terms “electrophoretic particle” and “electrophoretic particles”.

“First outside surface of a variable light transmission device” and “second outside surface of a variable light transmission device” are the outside surfaces of the device that are near the first light transmissive electrode layer and the second light transmissive electrode layer, respectively. As used herein, the term “outside surface” referring to a variable light transmission device, only refers to the main surfaces on the viewing sides of the variable light transmission device, not the smaller surface on the periphery of the device.

The term “edge”, as used herein, refers to a line where two surfaces meet and a portion of each of the two surfaces, the portion of each surface being adjacent to said line. The term “filleted edge”, as used herein, refers to an edge as defined above, which has a rounded transition between the two surfaces of the edge. Examples of non-filleted and filleted edges are illustrated in FIGS. 1A-1D. The parallel lines indicate solid material. FIG. 1A is a non-filleted edge that is formed by two solid surfaces A and B. FIG. 1B illustrates another non-filleted edge. FIG. 1C is a filleted edge that is formed by two solid surfaces C and D. Another filleted edge is illustrated in FIG. 1D.

“Exposed microcell bottom inside surface” is the part of the microcell bottom inside layer that is in contact with the electrophoretic medium, the exposed microcell bottom inside surface being in contact with the channel of the microcell. On the contrary, “unexposed microcell bottom inside surface” is the surface of the microcell bottom inside layer that is in contact with the protrusion structure; specifically, the unexposed microcell bottom inside surface is in contact with the protrusion structure base; in the case where the protrusion structure has a protrusion structure well, the unexposed microcell bottom inside surface is in contact with the solid part of the protrusion structure and with the protrusion structure well.

“Percent transparency of a variable light transmission device” (% T) at a location of the device is given by Equation 1. Thus, “percent transparency of a variable light transmission device” (% T) at a location of the device is the ratio of the intensity of light that is transmitted through the variable light transmission device and exiting from a location of the second outside surface of the variable light transmission device (I) to the intensity of light that enters the variable light transmission device from a location at the first outside surface of the variable light transmission device (Io) times 100; the location of the second outside surface of the variable light transmission device is symmetrical to the location of the first outside surface of the variable light transmission device with respect to a plane, the plane being at equal distance between the first light transmissive electrode layer and the second light transmissive electrode layer.

$$\% T = ( I / Io ) \times 100 \qquad ( Equation 1 )$$

The distance of a point from a plane is the shortest perpendicular distance from the point to the plane. The distance between two planes in a three-dimensional space is the shortest distance between the planes. It is the shortest distance between any point on one plane and any point on the other plane.

In the case that the protrusion structure of a microcell of a variable light transmission device of the present invention is a cone, and the protrusion structure does not have a protrusion structure well, the term “protrusion side surface” is a surface of the protrusion structure, not including the protrusion apex, that is in contact with the electrophoretic medium.

When the term “in contact with the electrophoretic medium”, referring to a surface in a microcell, is used herein, it is assumed that the entire available volume of a microcell is filled with the electrophoretic medium. Available volume is the volume of the microcell that is not occupied by solid.

A cone has a base, an apex, and a curved surface, the curved surface connecting the base to the apex. In the case of a protrusion being a cone, the protrusion structure not having a protrusion structure well, the term “protrusion side surface” is synonymous to the “curved surface” of the cone. The above definitions are also relevant to concave and convex cones.

The terms “cone”, “concave cone”, “convex cone”, as used herein, include geometric solids that have a circular base or an elliptical base.

In the case of a cone having a circular base, diameter of a base of the cone is the diameter A-B of the circular base. In the case of an elliptical cone, which is a cone having an elliptical base, the diameter of the base of the cone is the linear segment A-B connecting two points in the perimeter of the base of the cone, the linear segment A-B being the longest linear segment that connects any two points in the perimeter of the base. This definition also applied to convex and concave cones.

“Slope of a cone” is defined as the angle that has (a) vertex (A) on the circumference of the base of the cone, (b) first arm the line that connects point A (vertex) and the center of the base of the cone C, and (c) second arm the line that connects point A (vertex) and the apex of the cone.

As used herein, “slope of a concave cone” (or “slope of a convex cone”) is the angle that is formed by a diameter A-B of the base of the concave cone (or the convex cone) and linear segment B-C, where C is a point on the intersection of the curved surface of the concave cone (or the convex cone) and a plane P, plane P being parallel to the base of the concave cone (or the convex cone), the distance between the base and plane P being equal to the height of the concave cone (or the convex cone) divided by 10, linear segment B-C being the shortest linear segment between point B and any other point on the intersection of the curved surface of the concave cone (or the convex cone) and plane P.

“A conical frustum” is a portion of a cone obtained by cutting the apex portion with a plane parallel to the base of the cone. A conical frustum (or a concave conical frustum or a convex conical frustum) has a large base and a small base. A large base of the conical frustum (or the concave conical frustum or the convex conical frustum) has larger surface area than the small base of the conical frustum (or the concave conical frustum or the convex conical frustum). As used herein, the terms “conical frustum”, “concave conical frustum”, and “convex conical frustum” include geometric solids that have small and large circular bases or small and large elliptical bases.

In the case of a conical frustum having circular bases, diameter of a large base (or a small base) of the conical frustum is the diameter A-B of the circular base (or the small circular base). In the case of an elliptical conical frustum, that is a conical frustum having an elliptical large base, the diameter of the large base (or the small base) of the conical frustum is the linear segment A-B connecting two points in the perimeter of the large base of the conical frustum, the linear segment A-B being the longest linear segment that connects any two points in the perimeter of the large base. These definitions apply to convex and concave conical frustums.

Slope of a conical frustum is defined as the angle that has (a) vertex (A) on the circumference of the large base of the conical frustum, (b) first arm is the line that connects the vertex (A) and the center of the large base of the conical frustum C, and (c) second arm the line that is the intersection of the lateral surface of the conical frustum and a plane that includes the linear segment AC, the plane being vertical to the bottom base of the conical frustum.

As used herein, the term “first slope of a convex conical frustum” (or “first slope of a concave conical frustum”) is the angle that is formed by a diameter A-B of the large base of the convex conical frustum (or the large base of the concave cone) and linear segment B-C, where C is a point on the intersection of the curved surface of the convex cone (or the curved surface of the concave cone) and a plane P, plane P being parallel to the large base of the convex cone (or to the large base of the concave cone), the distance between the large base and plane P being equal to the height of the convex conical frustum (or the height of the concave conical frustum) divided by 10, linear segment B-C being the shortest linear segment between point B and any other point on the intersection of the curved surface of the convex conical frustum (or the curved surface of the concave conical frustum) and plane P. As used herein, the term “second slope of a convex conical frustum” (or the term “second slope of a concave conical frustum”) is the angle that is formed by a diameter D-E of the small base of the convex conical frustum (or the small base of the concave conical frustum) and linear segment E-F, where E is a point on the intersection of the curved surface of the convex conical frustum (or the curved surface of the concave conical frustum) and a plane Y, plane Y being parallel to the small base of the convex conical frustum (or to the small base of the concave conical frustum), the distance between the small base and plane Y being equal to the height of the convex conical frustum (or the height of the concave conical frustum) divided by 10, linear segment D-E being the shortest linear segment between point B and any other point on the intersection of the curved surface of the convex conical frustum (or the curved surface of the concave conical frustum) and plane Y.

A cylinder has a first base and a second base. As used herein, the term “cylinder” is a geometric solid that has circular first and second bases or elliptical first and second bases.

The term “electrically charged pigment particles” refers to electrically charged pigment particles that may or may not have any polymeric material on the surface of the pigment particles. The term “electrically charged pigment particles” is synonymous to “electrophoretic particles”.

A “microcell wall inside surface” is the surface of the microcell wall that is in contact with the electrophoretic medium of the microcell. As mentioned above, for this definition, it is assumed that the entire available volume of the microcell is filled with the electrophoretic medium.

A “microcell wall upper surface” is the surface of the microcell wall that is in contact with the sealing layer of the microcell. In the case that there is a light blocking layer on the microcell wall upper surface, the light blocking layer is disposed between the microcell wall upper surface and the sealing layer.

“Length of a microcell” is the longest distance between any point of the microcell opening (205) to any other point of the microcell opening (205). “Height of a microcell” is the distance between the plane that includes the microcell opening (205) and the plane that includes the microcell bottom inside surface (211).

“Channel base width” (216w) is the smallest distance between the inner base perimeter (224) and outer base perimeter (225) of the channel of a microcell.

“Adjacent microcells” are microcells that have a common wall.

The term “DC-balanced waveform” or “DC-balanced driving waveform” applied to a pixel is a driving waveform where the driving voltage applied to the pixel is substantially zero when integrated over the period of the application of the entire waveform. The DC balance can be achieved by having each stage of the waveform balanced, that is, a first positive voltage will be chosen such that integrating over the subsequent negative voltage results in zero or substantially zero. If the waveform is not DC-balanced, it is referred to as “DC-imbalanced waveform” or “DC-imbalanced driving waveform”. The driving waveform applied to a pixel may have a portion that is DC-imbalanced and at least one additional pulse of the opposite impulse to ensure that the overall waveform applied to a pixel is DC-balanced. This additional pulse may be applied before the DC-imbalanced portion of the waveform (pre-pulse). Typical examples of DC-imbalanced waveforms include (a) a square or sinusoidal AC waveform having a duty cycle of less (or more) than 50%, and (b) square or sinusoidal AC waveform that has a DC offset.

The term “impulse” is the integral of voltage with respect to time. That is, for a waveform pulse having a voltage V applied for time t, the impulse is V×t. The impulse can be positive, if the polarity of voltage V is positive, or negative, if the polarity of voltage V is negative.

The term “net positive impulse” of a waveform means that negatively electrically charged pigment particles will be attracted to and will move towards the first light transmissive electrode layer during the application of the waveform.

The term “lateral component of velocity” in relation to the movement of electrically charged pigment particles in a microcell of the variable light transmission device of the present invention is the velocity in the horizontal direction. For this definition, we assume that the velocity of the electrically charged particles is a vector resulting from the vector addition of the velocity in the horizontal direction (Vt), and the velocity in the vertical direction (Vv), and that the vertical direction in the case of the movement of the electrically charged pigment particles inside an electrophoretic microcell is the direction from the first light transmissive electrode layer to the second light transmissive electrode layer or form the second light transmissive electrode layer to the first light transmissive electrode layer. In the same system, the horizontal direction of the movement of the electrically charged pigment particles inside an electrophoretic microcell is the direction from one side of the microcell wall to the other side of the microcell wall, this direction being parallel to the first light transmissive electrode layer. Thus, the statement “the velocity of the electrically charged pigment particles has a lateral component” means that the magnitude of the velocity in the horizontal direction is larger than zero.

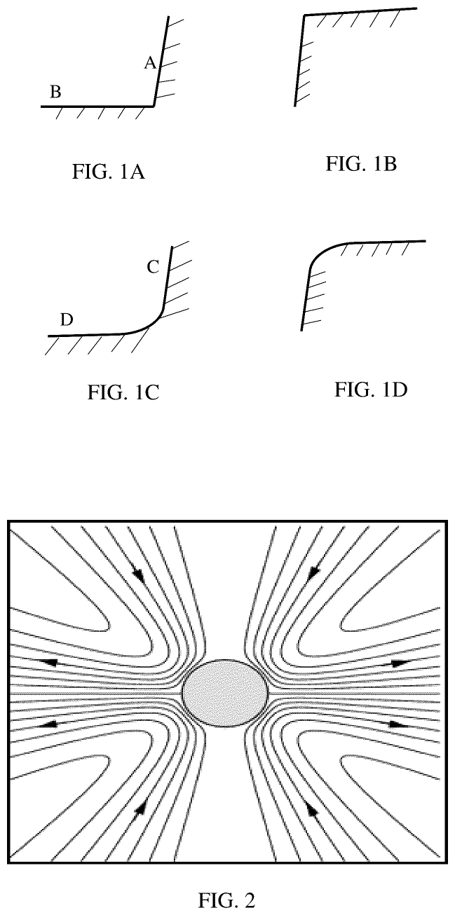

The phenomenon of Induced-Charge-Electro-Osmosis (ICEO) can be utilized to move polarizable particles, such as pigment particles, which are present in an electrophoretic medium, laterally. That is, the polarizable particles can move parallel to the electrode layers that sandwich the electrophoretic medium. In the presence of an electric field, a particle may experience a force, which is caused by polarization of the particle (or by polarization of an adsorbed conductive coating on the particle surface, or of the electrical double layer around the particle). This force may result in a perturbation in the flow of mobile charge, such as ions or charged micelles, in the electrophoretic medium, as shown in FIG. 2 for a cylindrical particle 101 surrounded by the liquid of the electrophoretic medium in the applied electric field. This figure is reproduced by the article of Bazant and Squires, J. Fluid Mech., 2004, 509, 217-252.

A perfectly symmetrical, spherical particle would experience no net force, but less symmetrical particles would experience forces having a component perpendicular to the direction of the applied field. The cooperative flows, which are created by a swarm of particles each experiencing such forces, can lead to “swirling” of an electrophoretic medium containing multiple particles. The maximum velocity u of this swirling for a particular particle, according to the theory advanced in the article by Bazant and Squires, would be given approximately by Expression 1.

$$u ∝ \frac{ε {RE}^{2}}{η ( 1 + {ω}^{2} {τ}^{2} )} \qquad ( Expression 1 )$$

In Expression 1, E is the field strength, ε is the dielectric constant of the solvent, η is the viscosity of the electrophoretic fluid, ω is the applied sinusoidal AC frequency, and τ is the time scale for building up a screening charge layer by motion of solvent-borne charges around charge. The time scale t is given by Equation 3.

$$τ = \frac{{λ}_{D} R}{D} \qquad ( Equation 3 )$$

In Equation 3, λ_{D} is the Debye screening length, R is the particle radius, and D is the diffusion constant of charge carriers in the fluid.

According to Expression 1, as the frequency is raised, the value of ω² τ² increases, and the maximum velocity of induced-charge flows decreases. Furthermore, for values of ω²τ² that are significantly larger than 1, the maximum swirling velocity is proportional to the square of the ratio E/ω. Induced-charge flows occur in the same direction regardless of the polarity of the applied electric field and can thus be driven by alternating fields.

When the electrophoretic medium is contained within a microcell, as is preferred in electrophoretic displays, the geometries of the induced flows are affected by the shape of the microcell used. For example, in the simplest case of two parallel electrodes, it was shown that, using an appropriate electric field strength and AC frequency, the flow can adopt a roll structure with periodic spacing that corresponds to the width of the gap between the electrodes.

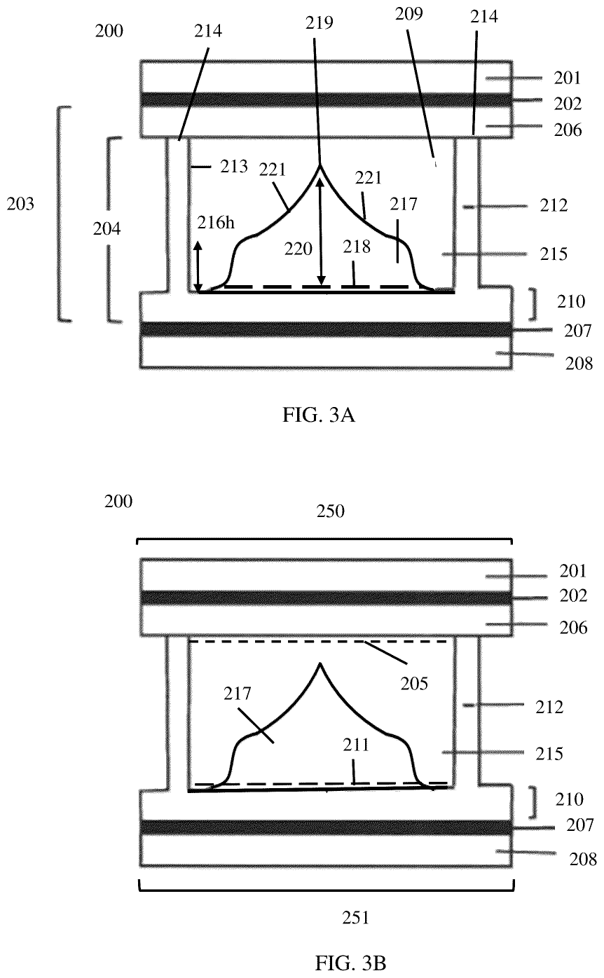

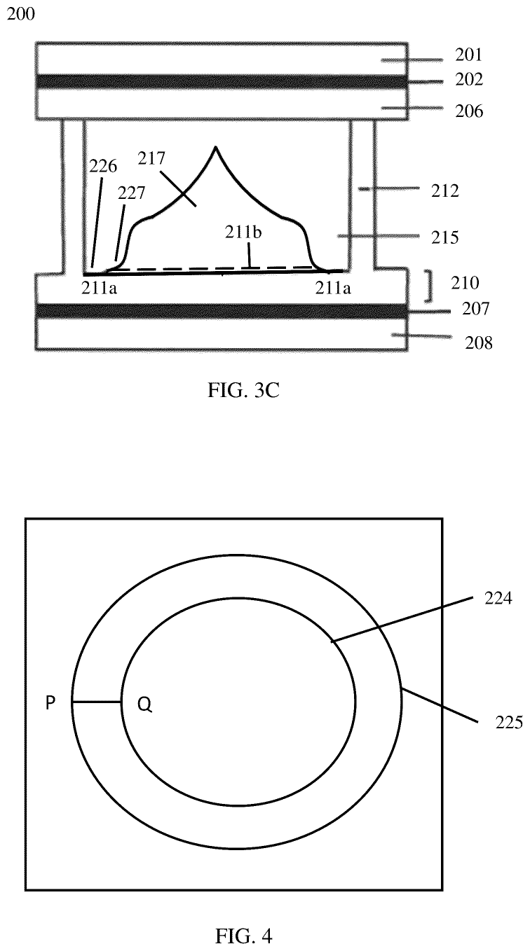

The inventors of the present invention used complex microcell structures that were formed by an embossing method to make variable light transmission devices. In one example, the embossed structure includes a protrusion structure on the bottom of each microcell. FIGS. 2A, 2B, and 2C illustrate a side view of a portion of an example of a variable light transmission device (200) according to the present invention. All three FIGS. 3A, 3B, 3C are identical in terms of the device structure that is illustrated, but different parts of the device are identified on each of the figures. That is, the figure of FIG. 3A is repeated in FIG. 3B and in FIG. 3C to facilitate the identification of the various parts and components of the device. These figures illustrate only a portion of the display (not in scale), showing only one microcell.

In a first embodiments of the present invention, variable light transmission device 200 comprises first light transmissive substrate 201, first light transmissive electrode layer 202, a microcell layer 203 comprising a plurality or microcells 204 and a sealing layer 206, second light transmissive electrode layer 207, and second light transmissive substrate 208. Each microcell of the plurality of microcells 204 comprises an electrophoretic medium 209 including electrically charged pigment particles and a non-polar liquid (not shown in FIGS. 3A, 3B, and 3C). Each microcell of the plurality of microcells 204 has a microcell opening 205, the sealing layer 206 spanning the microcell openings 205 of the plurality of microcells 204. Each microcell of the plurality of microcells 204 comprises microcell bottom layer 210, protrusion structure 217, a microcell wall 212, and channel 215. The protrusion structure (217) of the variable light transmission device of the first embodiment does not have a protrusion structure well.

Microcell bottom layer 210 has microcell bottom inside surface 211, the microcell bottom inside surface 211 comprising exposed microcell bottom inside surface 211a and unexposed microcell bottom inside surface 211b. Unexposed microcell bottom surface 211b is in contact with the protrusion base 218. Protrusion structure 217 has a protrusion base 218, a protrusion side surface 221, a protrusion apex 219, and a protrusion height 220. The protrusion apex 219 is a point or set of points of the protrusion structure 217 having shorter distance from microcell opening 205 than all other points of the protrusion structure 217. The protrusion height 220 is the distance between the protrusion base 218 and the protrusion apex 219. Microcell bottom layer 210 has microcell bottom inside surface 211, the microcell bottom inside surface 211 comprising exposed microcell bottom inside surface 211a and unexposed microcell bottom inside surface 211b. Unexposed microcell bottom surface 211b is in contact with the protrusion base 218.

Channel 215 is a three-dimensional shape that is defined by a space between exposed microcell bottom inside surface 211a, microcell wall inside surface 213, protrusion side surface 221, and a plane that is parallel to the microcell bottom inside surface (211), the plane having a distance from the microcell bottom inside surface (211) equal to the channel height (216h). Channel height 216h is 50% of the protrusion height 220. Channel width is the smallest distance between the inner base perimeter (224) and outer base perimeter (225) of a channel.

Channel 215 is a three-dimensional shape that is defined as a space between protrusion side surface 221, exposed microcell bottom inside surface 211a, microcell wall inside surface 213, and a plane that is parallel to the microcell bottom inside surface (211), the plane having a distance from the microcell bottom inside surface (211) equal to the channel height. Channel height is 50% of the protrusion height 220. Channel width is the smallest distance between the inner base perimeter (224) and outer base perimeter (225) of a channel.

FIG. 4 illustrates a top view of the microcell of the variable light transmission device of FIG. 3A-3C. The protrusion base in this variable light transmission device is circular as shown by the shape of the inner base perimeter (224) of the channel. P is a point on the outside base perimeter (224) of the channel (215) of the microcell. Q is a point on the inside base perimeter (225) of the channel (215) of the microcell. Points P and Q define a linear segment PQ that corresponds to the shortest distance between any point on the outer base perimeter (224) and any point on the inner base perimeter (225) of the channel (215) of the same microcell. Linear segment PQ corresponds to channel base width (216w).

Microcell wall 212 have microcell wall inside surface 213 and a microcell wall upper surface 214. The microcell wall inside surface 213 is in contact with electrophoretic medium 209. The microcell wall upper surface 214 is the surface of microcell wall 212 of a microcell that is in contact with sealing layer 206. Furthermore, FIG. 3B shows first outside surface 250 of the variable light transmission device being located on a side of the variable light transmission device that is near the first light transmissive electrode layer (202), and second outside surface (251) of the variable light transmission device being located on a side of the variable light transmission device that is near the second light transmissive electrode layer (207).

A microcell layer comprising a plurality of microcells 204 having protrusion structure 217 may be manufactured by embossing thermoplastic or thermoset precursor layer using a pre-patterned male mold, followed by releasing the mold. The precursor layer may be hardened by radiation, cooling, solvent evaporation, or other means during or after the embossing step.

The protrusion structure can direct the electrophoretic flow of particles into a channel to form the open optical state and onto the surface of the microcell near the sealing layer (206), which is adjacent to first light transmissive electrode layer 202 to form the close optical state. The electrically charged pigment particles would move towards the channel, if the electric field applied across the electrophoretic medium has the appropriate polarity in relation to the polarity of the electrically charged pigment particles. For example, the electrically charged pigment particles will move towards the channel, if the electrically charged pigment particles are positively charged and the applied voltage via the light transmissive electrodes results in negative polarity on the second light transmissive electrode. The same movement will take place if the electrically charged pigment particles are negatively charged and the applied voltage via the light transmissive electrodes results in positive polarity on the second light transmissive electrode.

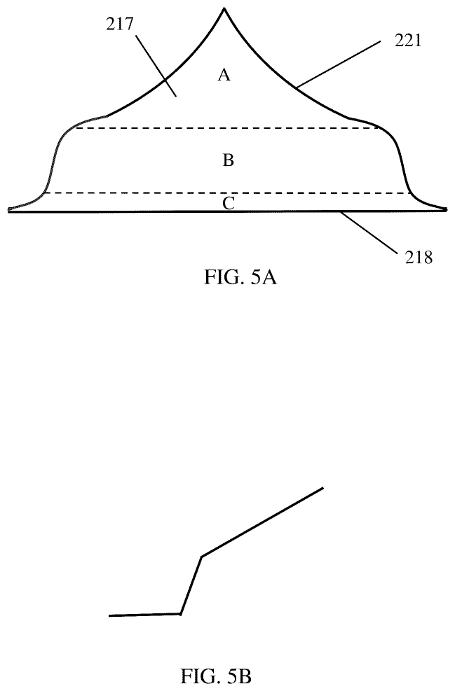

The protrusion structure 217 of the variable light transmission device 200 of FIGS. 3A-3C is a three-dimensional shape that consists of 3 different types of geometric solids. The side view of the protrusion structure 217 of a microcell of the variable light transmissive device 200 is illustrated in FIG. 5A. The three-dimensional shape consists of a concave cone (A) on a convex conical frustum (B) on a concave conical frustum (C). The profile curve of the protrusion side surface 221 on a plane, as illustrated in FIG. 5A, has two inflexion points, indicating the presence of the three geometric solids, the combination of which make up the three-dimensional shape of protrusion structure 217. The protrusion base is illustrated by 218 in FIG. 5A. The profile curve of the concave conical frustum C means that the edge formed by the protrusion structure and the microcell bottom inside surface at the location of the channel is filleted (rounded). Analogously, the profile curve of the convex conical frustum B means that, in the case that the protrusion structure includes a profile with a change in the slope, as illustrated in FIG. 5A, the transition from one slope to the other is also filleted (rounded). The rounding of the edges of the protrusion structure and the presence of the concave cone contribute to an efficient movement of the charged electrophoretic pigment particles from the channel (in open optical state) towards the sealing surface (closed optical state). FIG. 5B is a side view of part of a protrusion structure of a microcell of a non-inventive device, the protrusion that does not comprise filleted edges.

Protrusion structure 217 of the variable light transmission device of the first embodiment may be a three-dimensional shape that consists of different types of geometric solids. The three-dimensional shape of the protrusion structure may consist of one geometric solid or a combination of two or more geometric solids. The one geometric solid and each geometric solid of the combination of the two or more geometric solids of the three-dimensional shape of the protrusion structure (217) may be selected from the group consisting of a cone, a concave cone, a conical frustum, a concave conical frustum, a convex conical frustum, and a cylinder, the cone and the concave cone having a base, an apex, and a slope, the conical frustum having a large base, a small base, and a slope, the concave conical frustum and the convex conical frustum having a large base, a small base, a first slope, and a second slope, and the cylinder having a first base and a second base. In the case where the three-dimensional shape of the protrusion structure (217) consists of one geometric solid, the one geometric solid may be a cone or a concave cone, the apex of the cone or concave cone being the protrusion apex (219), and the base of the cone or concave cone being the protrusion base (218).

In the case where the three-dimensional shape of the protrusion structure (217) consists of two, three, or four geometric solids, the protrusion structure (217) is, respectively, a first geometric solid on a second geometric solid, a first geometric solid on a second geometric solid on a third geometric solid, or a first geometric solid on a second geometric solid on a third geometric solid on a fourth geometric solid. The first geometric solid comprises the protrusion apex (219). The first geometric solid may be a cone or a concave cone, and the apex of the cone or concave cone is the protrusion apex (219).

Examples of three-dimensional shapes of a protrusion structure of a microcell of a variable light transmission device of the first embodiment include the following:

(a) a concave cone on a cylinder, the first base of the cylinder being the protrusion base (218), the second base of the cylinder being in contact with the base of the concave cone, and the apex of the concave cone being the protrusion apex (219).

(b) a cone on a conical frustum, the large base of the conical frustum being the protrusion base (218), the small base of the conical frustum being in contact with the base of the cone, the apex of the cone being the protrusion apex (219), and the slope of the cone being larger than the slope of the conical frustum.

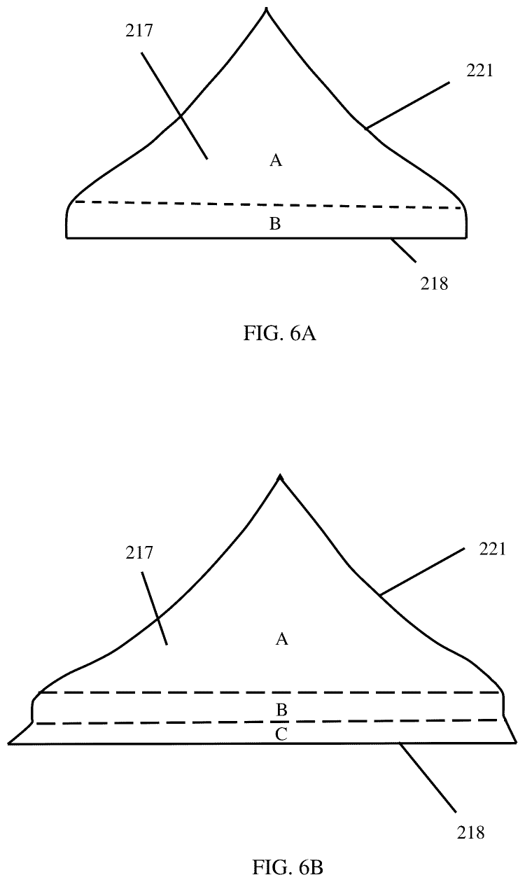

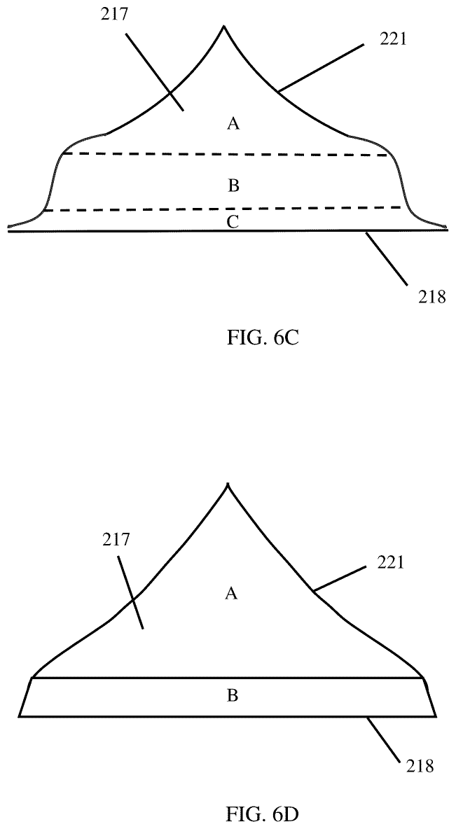

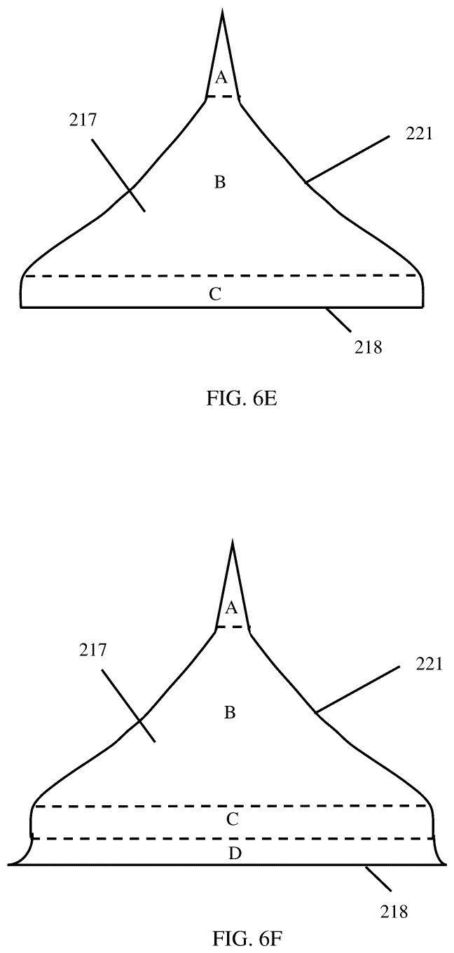

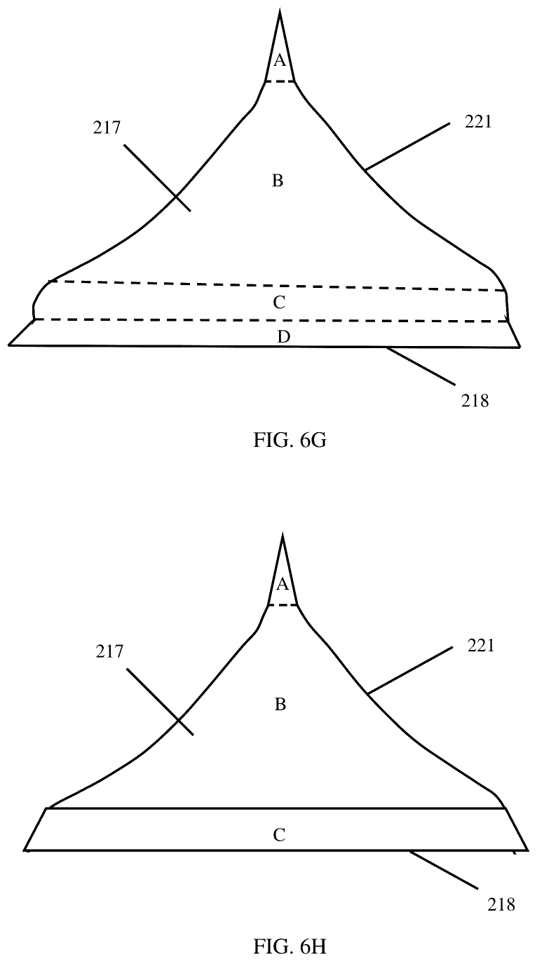

(c) a concave cone on a conical frustum, the large base of the conical frustum being the protrusion base (218), the small base of the conical frustum being in contact with the base of the concave cone, and the apex of the concave cone being the protrusion apex (219). A side view of this protrusion structure is illustrated in FIG. 6D.

(d) a cone or a concave cone on a concave conical frustum, the large base of the concave conical frustum being the protrusion base (218), the small base of the concave conical frustum being in contact with the base of the cone or concave cone, the apex of the cone or concave cone being the protrusion apex (219).

(e) a cone or a concave cone on a convex conical frustum, the large base of the convex conical frustum being the protrusion base (218), the small base of the convex conical frustum being in contact with the base of the cone or concave cone, and the apex of the cone or concave cone being the protrusion apex (219). A side view of this protrusion structure is illustrated in FIG. 6A.

(f) a cone or a concave cone on a convex conical frustum on a conical frustum, the large base of the conical frustum being the protrusion base (218), the small base of the conical frustum being in contact with the large base of the convex conical frustum, the small base of the convex conical frustum being in contact with the base of the cone or concave cone, the apex of the cone or concave being the protrusion apex (219), and the slope of the cone being larger than the second slope of the convex conical frustum. A side view of this protrusion structure (a concave cone on a convex conical frustum on a conical frustum) is illustrated in FIG. 6B.

(g) a cone or a concave cone on a convex conical frustum on a concave conical frustum, the large base of the concave conical frustum being the protrusion base (218), the small base of the concave conical frustum being in contact with the large base of the convex conical frustum, the small base of the convex conical frustum being in contact with the base of the cone or concave cone, and the apex of the cone or concave cone being the protrusion apex (219). A side view of this protrusion structure (a concave cone on a convex conical frustum on a concave conical frustum) is illustrated in FIG. 6C.

(h) a cone on a first conical frustum on a second conical frustum, the large base of the second conical frustum being the protrusion base (218), the small base of the second conical frustum being in contact with the large base of the first conical frustum, the small base of the first conical frustum being in contact with the base of the cone, the apex of the cone being the protrusion apex (219), and the slope of the first conical frustum being smaller than the slope of the cone.

(i) a concave cone on a first conical frustum on a second conical frustum, the large base of the second conical frustum being the protrusion base (218), the small base of the second conical frustum being in contact with the large base of the first conical frustum, the small base of the first conical frustum being in contact with the base of the concave cone, and the apex of the concave cone being the protrusion apex (219).

(j) a cone on a conical frustum on a concave conical frustum, the large base of the concave conical frustum being the protrusion base (218), the small base of the concave conical frustum being in contact with the large base of the conical frustum, the small base of the conical frustum being in contact with the base of the cone, the apex of the cone being the protrusion apex (219), and the slope of the conical frustum being smaller than the slope of the cone.

(k) a cone or a concave cone on a concave conical frustum on a convex conical frustum, the large base of the convex conical frustum being the protrusion base (218), the small base of the convex conical frustum being in contact with the large base of the concave conical frustum, the small base of the concave conical frustum being in contact with the base of the cone or the concave cone, and the cone apex or the concave cone apex being the protrusion apex (219). A side view of this protrusion structure (a cone on a concave conical frustum on a convex conical frustum) is illustrated in FIG. 6E.

(l) a cone on a conical frustum on a concave conical frustum, the large base of the concave conical frustum being the protrusion base (218), the small base of the concave conical frustum being in contact with the large base of the conical frustum, the small base of the conical frustum being in contact with the base of the cone, the apex of the cone being the protrusion apex (219), and the slope of the cone being larger than the slope of the conical frustum.

(m) a concave cone on a conical frustum on a concave conical frustum, the large base of the concave conical frustum being the protrusion base (218), the small base of the concave conical frustum being in contact with the large base of the conical frustum, the small base of the conical frustum being in contact with the base of the concave cone, and the apex of the concave cone being the protrusion apex (219).

(n) a cone or a concave cone on a convex conical frustum on a concave conical frustum on a conical frustum, the large base of the conical frustum being the protrusion base (218), the small base of the conical frustum being in contact with the large base of the concave conical frustum, the small base of the concave conical frustum being in contact with the large base of the convex conical frustum, the small base of the convex conical frustum being in contact with the base of the cone or concave cone, and the apex of the cone or concave cone being the protrusion apex (219).

(o) a cone or a concave cone on a convex conical frustum on a first concave conical frustum or a conical frustum, on a second concave conical frustum, the large base of the second concave conical frustum being the protrusion base (218), the small base of the second concave conical frustum being in contact with the large base of the first concave conical frustum or conical frustum, the small base of the first concave conical frustum or conical frustum being in contact with the large base of the convex conical frustum, the small base of the convex conical frustum being in contact with the base of the cone or concave cone, and the apex of the cone or concave cone being the protrusion apex (219).

(p) a cone or a concave cone on a first concave conical frustum on a convex conical frustum on a second concave conical frustum, the large base of the second concave conical frustum being the protrusion base (218), the small base of the second concave conical frustum being in contact with the large base of the convex conical frustum, the small base of the convex conical frustum being in contact with the large base of the first concave conical frustum, the small base of the first concave conical frustum being in contact with the base of the cone or concave cone, and the apex of the cone or concave cone being the protrusion apex (219). A side view of this protrusion structure (a cone on a first concave conical frustum on a convex conical frustum on a second concave conical frustum) is illustrated in FIG. 6F.

(q) a cone or a concave cone on a concave conical frustum on a convex conical frustum on a conical frustum, the large base of the conical frustum being the protrusion base (218), the small base of the conical frustum being in contact with the large base of the convex conical frustum, the small base of the convex conical frustum being in contact with the large base of the concave conical frustum, the small base of the concave conical frustum being in contact with the base of the cone or concave cone, and the apex of the cone or concave cone being the protrusion apex (219). A side view of this protrusion structure (a cone on a concave conical frustum on a convex conical frustum on a conical frustum) is illustrated in FIG. 6G.

(r) a cone or a concave cone on a concave conical frustum on a conical frustum, the large base of the conical frustum being the protrusion base (218), the small base of the conical frustum being in contact with the large base of the concave conical frustum, the small base of the concave conical frustum being in contact with base of the cone or concave cone, and the apex of the cone or concave cone being the protrusion apex (219). A side view of this protrusion structure (a cone on a concave conical frustum on a convex conical frustum on a conical frustum) is illustrated in FIG. 6H.

The protrusion structure that corresponds to FIG. 6E has a similarity to the protrusion structure that corresponds to FIG. 6A. The difference is that the protrusion structure that corresponds to FIG. 6E has a steepled part (cone A). The steepled part can be a cone (or a concave cone) having a slope that is larger than the slope of the geometric solid that is in contact with the cone (or concave cone) near the contact position; in the case of the protrusion structure of FIGS. 6A and 6E, the geometric solid is a concave conical frustum, the concave conical frustum having a slope near the contact position that is lower than the slope of the cone. In the case that the apex of the protrusion structure being a concave cone that is in contact with a concave conical frustum, the slope of the concave cone near the contact position is larger than the slope of the concave conical frustum near the contact position. Similarly, the protrusion structures illustrated in FIGS. 6F, 6G, 6H have a similarity to the protrusion structures illustrated in FIGS. 6C, 6B, and 6D. In protrusion structures having a steepled part (FIGS. 6E to 6H), the steepled part increases the velocity of charged electrophoretic pigment particles at the inflection points. Generally, the apex of the protrusion structures of FIGS. 6A, 6B, 6C, and 6D is a location where the velocity of the charged electrophoretic pigment particles is lower (in comparison to that of FIGS. 6A, 6C, 6B, and 6D) as the particles move towards the sealing layer surface to cause the closed optical state.

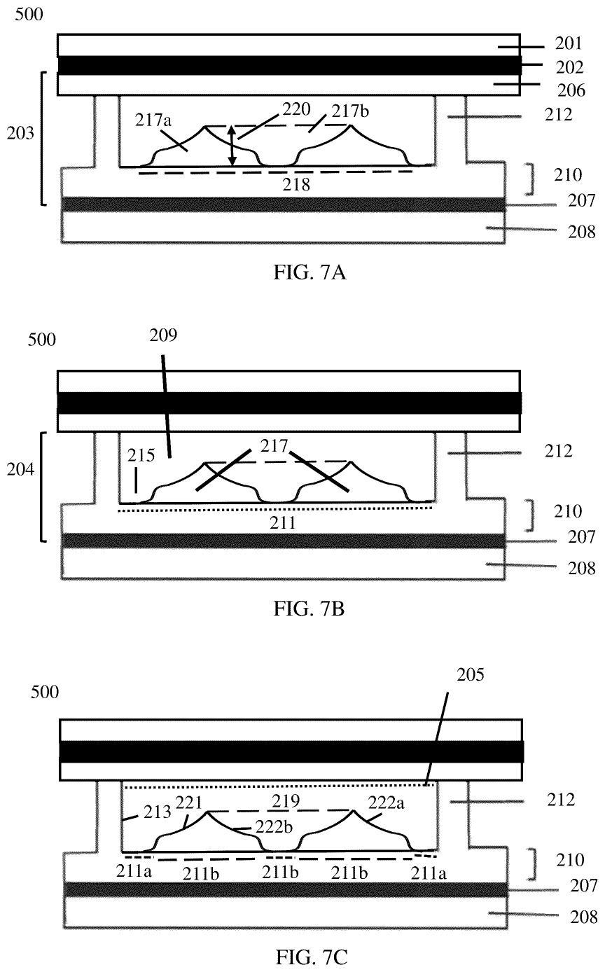

In a second embodiment of the present invention, variable light transmission device 500 is illustrated in FIGS. 7A, 7B, and 7C. All three FIGS. 7A, 7B, 7C are identical in terms of the device structure that is illustrated, but different parts of the device are identified on each of the figures. That is, the figure of FIG. 7A is repeated in FIG. 7B and in FIG. 7C to facilitate the identification of the various parts and components of the device. These figures illustrate only a portion of the display (not in scale), showing only one microcell. Variable light transmission device 500 comprises first light transmissive substrate 201, first light transmissive electrode layer 202, a microcell layer 203 comprising a plurality or microcells 204 and a sealing layer 206, second light transmissive electrode layer 207, and second light transmissive substrate 208. Each microcell of the plurality of microcells 204 comprises an electrophoretic medium 209 including electrically charged pigment particles and a non-polar liquid (not shown in FIGS. 7A, 7B, and 7C). Each microcell of the plurality of microcells 204 has a microcell opening 205, the sealing layer 206 spanning the microcell openings 205 of the plurality of microcells 204. Each microcell of the plurality of microcells 204 comprises microcell bottom layer 210, protrusion structure 217, microcell wall 212, and channel 215.

Microcell bottom layer 210 has microcell bottom inside surface 211, the microcell bottom inside surface 211 comprising exposed microcell bottom inside surface 211a and unexposed microcell bottom inside surface 211b. Unexposed microcell bottom surface 211b is in contact with the protrusion base 218. Protrusion structure 217 has a protrusion base 218, a protrusion side surface 221, a protrusion apex 219, and a protrusion height 220. The protrusion apex 219 is a point or set of points of the protrusion structure 217 having shorter distance from microcell opening 205 than all other points of the protrusion structure 217. The protrusion height 220 is the distance between the protrusion base 218 and the protrusion apex 219. Microcell bottom layer 210 has microcell bottom inside surface 211, the microcell bottom inside surface 211 comprising exposed microcell bottom inside surface 211a and unexposed microcell bottom inside surface 211b. Unexposed microcell bottom surface 211b is in contact with the protrusion base 218.

Microcell wall 212 has a microcell wall inside surface 213 and a microcell wall upper surface 214. The microcell wall inside surface 213 is in contact with electrophoretic medium 209. The microcell wall upper surface 214 is the surface of microcell wall 212 of a microcell that is in contact with sealing layer 206.

A microcell layer comprising a plurality of microcells 204 having protrusion structure 217 may be manufactured by embossing thermoplastic or thermoset precursor layer using a pre-patterned male mold, followed by releasing the mold. The precursor layer may be hardened by radiation, cooling, solvent evaporation, or other means during or after the embossing step.

The protrusion structure (217) of variable light transmission device 500 has a protrusion structure (217), a protrusion base (218), a protrusion base surface, a protrusion apex (219), a protrusion apex surface, and a protrusion height (220). The protrusion structure (217) consists of a solid part of protrusion structure (217a) and a protrusion structure well (217b).

The protrusion structure well (217b) has a volume that is filled with electrophoretic medium (209). The protrusion structure well (217b) has a three-dimensional shape consisting of one geometric solid or a combination of two or more geometric solids. The one geometric solid and each geometric solid of the combination of two or more geometric solids of the three-dimensional shape of the protrusion structure well (217b) are selected from the group consisting of a cone, a concave cone, a convex cone, a conical frustum, a concave conical frustum, a convex conical frustum, and a cylinder. The cone, the concave cone, and the convex cone have a base, an apex, and a slope. The conical frustum has a large base, a small base, and a slope. The concave conical frustum and the convex conical frustum have a large base, a small base, a first slope, and a second slope. The cylinder has a first base and a second base.

The protrusion side surface of the variable light transmission electro-optic device of the second embodiment is a surface of the solid part of the protrusion structure (217a), not including the protrusion apex (219), that is in contact with the electrophoretic medium (209). The protrusion side surface consists of a protrusion inside surface (222b) and a protrusion outside surface (222a). The protrusion inside surface (222b) is in contact with the protrusion structure well (217b) and the protrusion outside surface (222a) is the protrusion side surface without the protrusion inside surface (222b).

The protrusion structure well (217b) has a protrusion structure well base (218b). The protrusion structure well base (218b) is a surface of the three-dimensional shape of the protrusion structure well (217b) that is in contact with the microcell bottom inside surface (211). The three-dimensional shape of the protrusion structure well (217b) is defined by a space between (i) a plane that is parallel to the plane of the protrusion base (218) and includes the protrusion apex (219), (ii) the protrusion inside surface (222b), and (iii) the microcell bottom inside surface (211).

The three-dimensional shape of the protrusion structure well (217b) may consist of one, two, three, or four geometric solids. Examples of three-dimensional shapes of the protrusion structure well are: (a) a concave conical frustum, the large base of the concave conical frustum being the protrusion base (218) and the small base of the concave conical frustum being the protrusion apex (219); (b) a concave conical frustum on a cylinder, the first base of the cylinder being the protrusion base (218), the second base of the cylinder being in contact with the large base of the concave conical frustum, and the small base of the being the concave conical frustum being the protrusion apex (219); (c) a first conical frustum on a second conical frustum, the large base of the second conical frustum being the protrusion base (218), the small base of the second conical frustum being in contact with the large base of the first conical frustum, and the small base of the first conical frustum being the protrusion apex (219); (d) a concave conical frustum on a conical frustum, the large base of the conical frustum being the protrusion base (218), the small base of the conical frustum being in contact with the large base of the concave conical frustum, and the small base of the concave conical frustum being the protrusion apex (219); (e) a first concave conical frustum on a second concave conical frustum, the large base of the second concave conical frustum being the protrusion base (218), the small base of the second concave conical frustum being in contact with the large base of the first concave conical frustum, and the small base of the first concave conical frustum being the protrusion apex (219); (f) a conical frustum on a convex conical frustum, the large base of the convex conical frustum being the protrusion base (218), the small base of the convex conical frustum being in contact with the large base of the conical frustum, and the small base of the conical frustum being the protrusion apex (219); (g) a concave conical frustum on a convex conical frustum, the large base of the convex conical frustum being the protrusion base (218), the small base of the convex conical frustum being in contact with the large base of the concave conical frustum, and the small base of the concave conical frustum being the protrusion apex (219).

The three-dimensional shape of the protrusion structure of a microcell of a variable light transmission device of the second embodiment may consist of a first geometric solid on a second geometric solid on a third geometric solid. The first geometric solid may be a conical frustum or a concave conical frustum. The second geometric solid may be a conical frustum, a concave conical frustum, or a convex conical frustum. The third geometric solid may be a conical frustum, a concave conical frustum, or a convex conical frustum. The large base of the conical frustum, a concave conical frustum, or a convex conical frustum of the third geometric solid is the protrusion base (218). The small base of the conical frustum, a concave conical frustum, or a convex conical frustum of the third geometric solid is in contact with the large base of the conical frustum, a concave conical frustum, or a convex conical frustum of the second geometric solid. The small base of the conical frustum, a concave conical frustum, or a convex conical frustum of the second geometric solid is in contact with the large base of the conical frustum or the concave conical frustum of the first geometric solid. The small base of the conical frustum or the concave conical frustum of the first geometric solid is the protrusion apex (219).

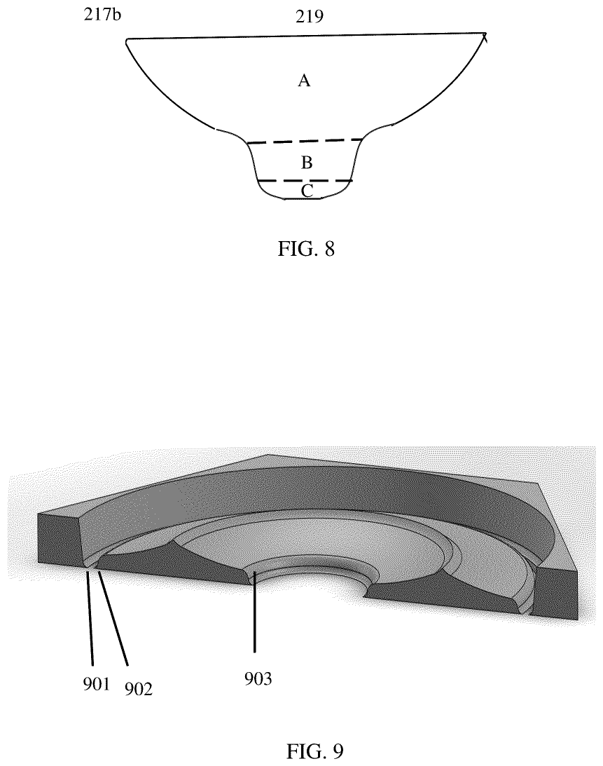

The protrusion structure well 217b of the variable light transmission device of FIG. 7A is illustrated in FIG. 8. FIG. 8 shows protrusion apex 219, first convex conical frustum (A), a concave conical frustum (B), and a second convex conical frustum (C).

FIG. 9 illustrates a prospective view of the microcell of the variable light transmission device that was illustrated in FIG. 7A. The prospective view includes a cross-section. Both the first and the second edges (901, 902) of the device are filleted. The edge in the protrusion inside surface (903) is also filleted.

The solid part of the protrusion structure of a microcell of a variable light transmission device of the second embodiment may comprise a steepled part, as discussed above in the case of the protrusion structure of a microcell of a variable light transmission device of the first embodiment. The steepled part can be a cone (or a concave cone) having a slope that is larger than the slope of the geometric solid that is in contact with the cone (or concave cone) near the contact position. In the case where a steepled part of the protrusion structure is a cone and the base of the cone is in contact with a small base of a conical frustum, a small base of concave conical frustum, or a small base of a convex conical frustum, the slope of the cone is larger than (i) the slope of the conical frustum, (ii) the second slope of the concave conical frustum, or (iii) the second slope of the convex conical frustum.

The protrusion structure of the microcells of the variable light transmission device according to the first embodiments can direct the electrophoretic flow of particles into the channel to form the open optical state and onto the surface of the microcell near the sealing layer to form the closed optical state. The protrusion structure of the microcells of the variable light transmission device according to the second embodiment can direct the electrophoretic flow of particles into the channel and the protrusion structure well to form the open optical state and onto the surface of the microcell near the sealing layer to form the close optical state. The electrically charged pigment particles will move towards the channel (first embodiment) or towards the channel and protrusion structure well (second embodiment), if the electric field, which applied across the electrophoretic medium, has the appropriate polarity in relation to the polarity of the electrically charged pigment particles. For example, the electrically charged pigment particles will move towards the channel (or channel and the protrusion structure well), if the electrically charged pigment particles are positively charged and the applied voltage via the light transmissive electrodes results in negative polarity on the second light transmissive electrode. The same movement will take place if the electrically charged pigment particles are negatively charged and the applied voltage via the light transmissive electrodes results in positive polarity on the second light transmissive electrode. The variable light transmission device of the first embodiment and second embodiment of the present invention may be switched from an open optical state (transparent state or light transmissive state) to a closed optical state (opaque state) by application of an electric field across the electrode layers.

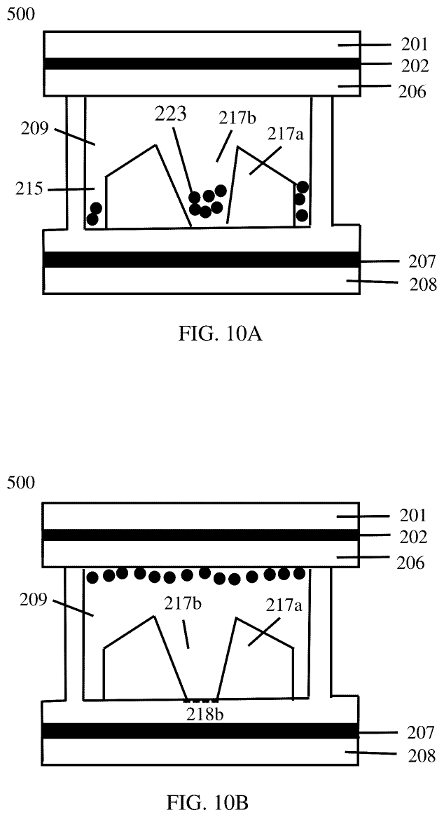

FIGS. 10A and 10B illustrate the switching to the optical states of variable light transmission device 500 (second embodiment). When a first electric field is applied between the first light transmissive electrode layer 202 and the second light transmissive electrode layer 207 via a first waveform, movement of the electrically charged pigment particles 223 towards the protrusion structure well (217b) is caused when the polarity of the electrically charged pigment particles 223 and the voltage polarity of the second light transmissive electrode layer are opposite to each other. If the polarity of the electrically charged pigment particles 223 and the voltage polarity of the second light transmissive electrode layer are opposite to each other, the electrically charged pigment particles 223 will be attracted by the second light transmissive electrode, and the variable light transmission device will switch to an open optical state, the open optical state having higher percent transparency than the closed optical state. The open optical state is illustrated in FIG. 10A, where electrically charged pigment particles 223 are represented by black filled circles. In this example, the electrophoretic medium comprises one type of electrically charged pigment particles 223. In the open optical state, the electrically charged pigment particles 223 are present in the protrusion structure well of the microcell.

Application of a second electric field between the first light transmissive electrode layer 202 and the second light transmissive electrode layer 207 via a second waveform causes a movement of the electrically charged pigment particles 223 towards the first light transmissive electrode layer 202 with a velocity. This leads to the closed optical state, which is shown in FIG. 10B. The velocity may have a lateral component. In the absence of a lateral component of the velocity, the closed optical state will be less effective, because the electrically charged pigment particles 223 will move from the protrusion structure well towards the first light transmissive electrode layer 202, but these electrically charged pigment particles 223 will occupy an area near the center of a microcell at the vicinity of the sealing layer 206. Similarly, in the absence of a lateral component of the velocity, the electrically charged pigment particles 223 will move from the channel towards the first light transmissive electrode layer 202, but these electrically charged pigment particles 223 will occupy an area near the sides of a microcell at the vicinity of the sealing layer 206. That is, electrically charged pigment particles 223 will not be well-spread across all of the surface of the first light transmissive electrode layer 202 and the closed optical state will not be effectively formed, because the closed optical state will have relatively high light transmittance.

The above indicates that it is somewhat easier to achieve a transition from the closed optical state to the open optical state, because the slope of the protrusion structure (for example, the cone of FIGS. 10A and 10B) will impart a lateral component to the velocity of the electrically charged pigment particles when they strike the protrusion side surface of the protrusion structure during their movement towards second light transmissive electrode layer.

The variable light transmission device may be switched to an open optical state by applying a first electric field between the first light transmissive electrode layer and the second light transmissive electrode layer via a first waveform to cause movement of the electrically charged pigment particles towards the channel (and the protrusion structure well), resulting in the switching of the variable light transmission device to an open optical state. The variable light transmission device may be switched to an closed optical state by applying a second electric field between the first light transmissive electrode layer and the second light transmissive electrode layer via a second waveform to cause a movement of the first type of electrically charged pigment particles towards the first light transmissive electrode layer with a velocity, the velocity having a lateral component, and leading to a closed optical state, the second waveform comprising a series of at least two positive and negative pulses having a net positive or net negative impulse, wherein the closed optical state has lower percent transparency than the open optical state.

The second waveform may be DC-imbalanced. The second waveform may comprise at least one positive voltage and at least one negative voltage, the second waveform having a net positive or a net negative impulse. The choice of a net positive or net negative impulse depends on the polarity of the electrically charged pigment particles to be moved to the location of the electrophoretic medium near the sealing layer. Specifically, if the closed state involves movement of the electrically charged pigment particles that are negatively charged, a net positive impulse is required to move those particles from the protrusion structure well and the channel towards the first light transmissive electrode layer. In other words, this movement requires that the net result of the applied voltage be an attraction of the negatively charged particles by a positive voltage of the first light transmissive electrode layer in relation to the second light transmissive electrode layer. On the contrary, if the closed state involves movement of the electrically charged pigment particles that are positively, a net negative impulse is required to move the electrically charged pigment particles from the protrusion structure well and the channel near the second light transmissive electrode layer 207 towards the first light transmissive electrode layer.

A second electric field that is applied between the two light transmissive electrode layers via a second waveform achieves a closed optical state.

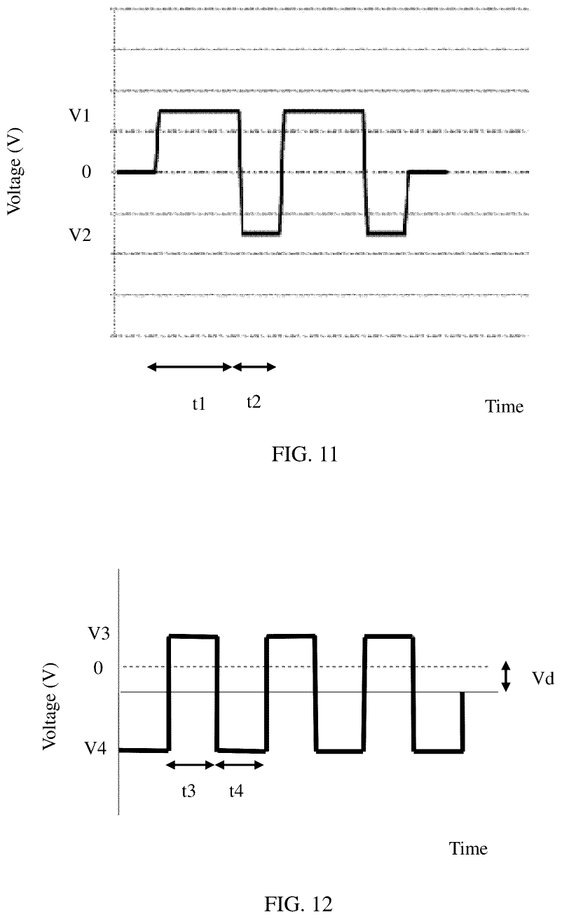

The second waveform may comprise an AC waveform, having a duty cycle different from 50%. An example of the second waveform is illustrated in FIG. 11.

The AC waveform may have a positive or negative DC bias. DC bias may be achieved by controlling the duty cycle of the waveform. The duty cycle for a positively DC biased waveform is higher than 50%. The duty cycle of a positively DC biased waveform may be higher than 55%, higher than 60%, or higher than 65%. The duty cycle for a positively DC biased waveform may be from 55% to 95%, from 58% to 90%, from 60% to 88%, from 65% to 85%, or from 70% to 80%. Analogously, the duty cycle for a negatively DC biased waveform is lower than 50%. The duty cycle for a negatively DC biased waveform may be lower than 45%, lower than 40%, or lower than 35%. The duty cycle for a negatively DC biased waveform may be from 5% to 45%, from 8% to 40%, from 10% to 38%, from 15% to 35%, or from 20% to 30%.

The waveform illustrated in the example of FIG. 11 comprises an AC square waveform having two or more cycles. Each cycle may comprise a first pulse of amplitude V1 applied for time period t1 and a second pulse of amplitude V2 applied for time period t2, wherein V1 is positive and V2 is negative, and wherein t1 is larger than t2. In the case that the amplitude of V1 is equal to the amplitude of V2 (|V1|=|V2|), a DC bias is achieved by the difference in the time periods. In the case of the example of FIG. 11, there is a positive DC bias, because the positive voltage V1 is applied for a longer time period (t1) than that of the negative voltage V2 (t2). Positive DC bias means that, if the electrically charged pigment particles of the variable light transmission device are negatively charged, the electrically charged pigment particles will move towards the first light transmissive electrode layer of the device. The duty cycle of the waveform can be calculated by Equation 4.

$$Duty Cycle = 100 \times ( V 1 \cdot t 1 ) / [ ( V 1 \cdot t 2 ) + ( V 2 \cdot t 2 ) ] \qquad ( Equation 4 )$$

In the waveform example of FIG. 11, the amplitude of V1 can be equal to the amplitude V2 (|V1|=|V2|), but, in general, the amplitudes V1 and V2 may be different from each other.

The example of the driving waveform of FIG. 11 is DC-imbalanced. However, one or more additional pulses may be included in the waveform of FIG. 11 of the opposite impulse, which can ensure that the overall waveform applied on a pixel is DC-balanced. This additional pulse (or additional pulses) may be applied before the DC-imbalanced waveform (pre-pulse). Also, the example of the waveform of FIG. 11 is a square AC waveform. Other examples of AC waveforms that can be used include sinusoidal waveforms, trigonal waveforms, and sawtooth waveforms.

The AC waveform may have an amplitude of from 10V to 200V and a frequency of from 0.1 to 6000 Hz. The AC waveform may have an amplitude of from 15V to 180V, from 20V to 160V, from 25V to 150V, or from 30V to 140V. The AC waveform may have a frequency of from 0.5 Hz to 5000 Hz, from 1 Hz to 4000 Hz, from 5 Hz to 3000 Hz, from 10 Hz to 2000 Hz, from 15 Hz to 1000 Hz, from 20 Hz to 800 Hz, or from 25 to 600 Hz. The ratio of the frequency of the AC waveform to the weight percent content of the charge control agent by weight of the electrophoretic medium may be from 400 Hz to 2000 Hz.

The second waveform may comprise a waveform that is formed by a superposition of a DC voltage component and an AC waveform. An example of the second waveform is illustrated in FIG. 12.

The waveform of FIG. 12 has a net negative impulse because of a DC offset (Ved). Although the period of time (t3) of the application of positive pulse is equal to the period of time (t4) of the application of negative pulse, a DC bias is achieved by the difference in the amplitudes of the pulses. Specifically, amplitude V3 of the positive pulse is smaller than amplitude V4 of the negative pulse. This is caused by the DC voltage component Vt of the waveform. That is, the waveform illustrated in FIG. 12 has a DC offset.

The example of the driving waveform of FIG. 12 is DC-imbalanced. However, one or more additional pulses may be included in the waveform of FIG. 12 of the opposite impulse, which can ensure that the overall waveform applied on a pixel is DC-balanced. This additional pulse (or additional pulses) may be applied before the DC-imbalanced waveform (pre-pulse). Also, the example of the waveform of FIG. 12 is a square AC waveform. Other examples of AC waveforms that may be used include a sinusoidal waveform, a trigonal waveform, and a sawtooth waveform.

The AC waveform may have an amplitude of from 10V to 200V and a frequency of from 0.1 to 6000 Hz. The AC waveform may have an amplitude of from 15V to 180V, from 20V to 160V, from 25V to 150V, or from 30V to 140V. The AC waveform may have a frequency of from 0.5 Hz to 5000 Hz, from 1 Hz to 4000 Hz, from 5 Hz to 3000 Hz, from 10 Hz to 2000 Hz, from 15 Hz to 1000 Hz, from 20 Hz to 800 Hz, or from 25 to 600 Hz. The ratio of the frequency of the AC waveform to the weight percent content of the charge control agent by weight of the electrophoretic medium may be from 400 Hz to 2000 Hz.

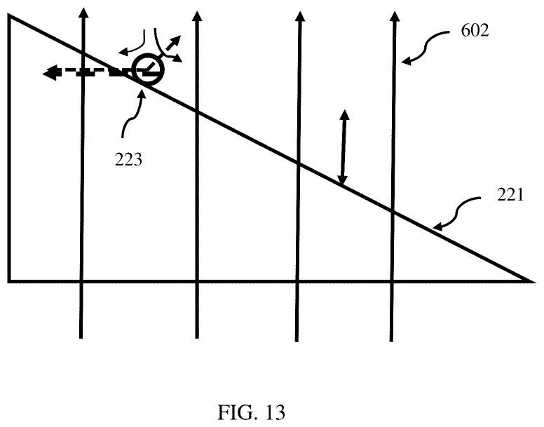

In a case where the ICEO-induced motion of the electrically charged pigment particles is relatively low, the protrusion structure of the microcell contributes to an effective operation of the variable light transmission device, even if the device is driven using a DC-balanced AC waveform. In the example of the protrusion structure having a protrusion structure well having a surface with a slope, any electrically charged pigment particles that are located at the surface will experience a net force that will move them upwards, as shown in FIG. 13. FIG. 13 shows electrically charged pigment particle 223 in contact with protrusion structure well in an electric field 602. In this case, the ICEO flows are illustrated by the curved arrows, being more constrained on the “uphill” side of the cone than the “downhill” side. This imparts a force to the particle shown by the dotted horizontal arrow. There will be an opposing force perpendicular to the cone, forcing the particle upwards. With an appropriate choice of AC fields and frequencies, the particles can be moved out of the protrusion structure well. The same concept is relevant to particles that are located in a channel, if the geometry of the channel comprises a surface having a similar slope.

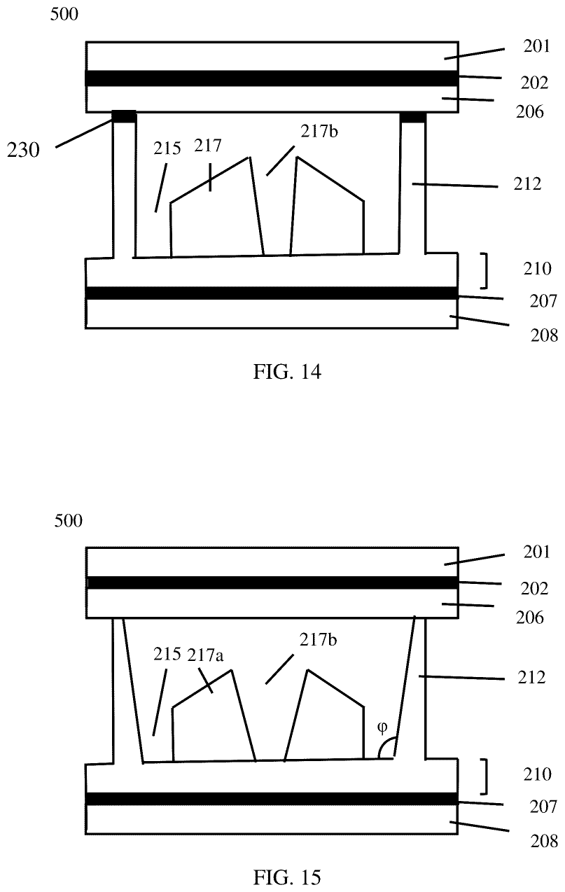

The microcells of the variable light transmission device of the first and second embodiments of the present invention may also comprise a light blocking layer (230), as shown in FIG. 14. Light blocking layer 230 is disposed between the microcell upper surface and sealing layer 206. Light blocking layer 230 may comprise a light absorbing pigment. The light absorbing pigment of the light blocking layer may have black color. The inventors of the present invention found that light blocking layer 230 contributes to an improved closed state by increasing the opacity of the device that may be caused by a partially light transmissive wall material. Light blocking layer 230 may be electrically conductive, which may facilitate the switching of the device.

FIG. 15 illustrates a variable light transmission device of the second embodiment (500) comprising light transmissive substrate 201, first light transmissive electrode layer 202, microcell layer comprising a plurality of microcells and a sealing layer 206 (herein only one microcell of the plurality of microcells is shown), second light transmissive electrode layer 207, and second light transmissive substrate 208. The microcell comprises microcell wall 212, channel 215, solid part of the protrusion structure 217a, protrusion structure well 217b, and microcell bottom 210. In the microcell of the variable light transmission device of FIG. 15, the microcell inside wall surface (213) forms an angle (φ) with microcell bottom inside surface (211), the angle being larger than 90 degrees. The inventors of the present invention found that such a structure significantly facilitates the embossing process for the making of the plurality of microcells, by enabling smooth removal of the embossing tool that does not damage the microcell wall. Angle q may be from 90 to 120 degrees, 93 to 117 degrees, 95 to 115 degrees, 98 to 118 degrees, or 100 to 115 degrees. The same is true for variable light transmission devices according to the first embodiment.

The variable light transmission devices of the first and second embodiments of the present invention show improved flow of the charged electrophoretic pigment particles towards the open and close optical states. The improved flow is observed partly because of the filleted edges at the channel (and the protrusion structure well). Without these filleted edges, flow within the microcell is broken up into two or more circular flows, one large flow above the protrusion structure, and smaller flows in the channel (and protrusion structure well). The recirculating part of the flows in the channel (and protrusion structure well) does not fully contribute to the motion of the charged electrophoretic pigment particles towards the close optical state. The fillets enable the merge of these separate flows into a continuous flow that carries the charged electrophoretic pigment particles from the channel and protrusion strucure well, causing the close optical state of the microcell.

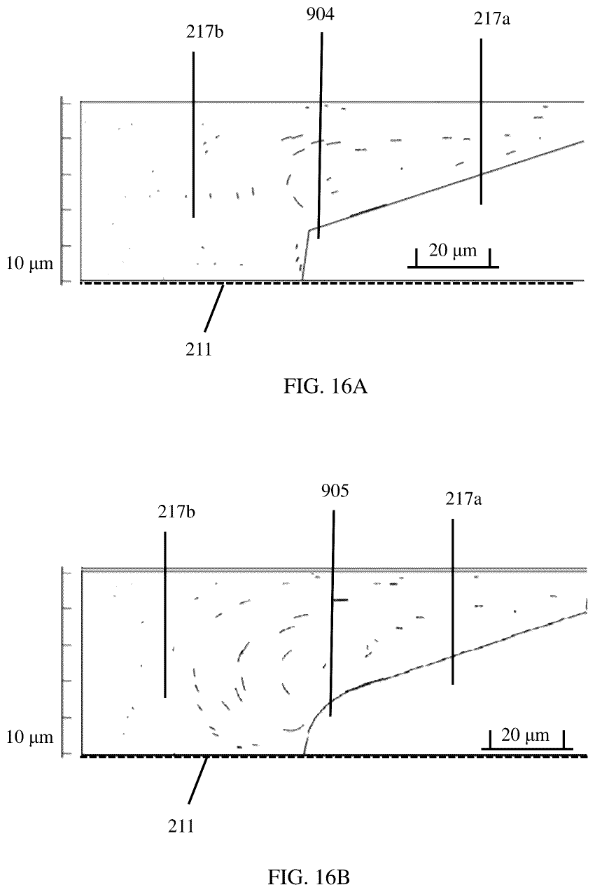

The filleted edge in the protrusion structure well of the microcell increases the velocity of the electrophoretic particles towards the closed optical state, as demonstrated by finite element modeling studies, using the COMSOL multi-physics tool based on the parameters of the second embodiment. Results of the modeling studies are shown in FIG. 16A and FIG. 16B. FIG. 16A illustrates a side view of part of a protrusion structure well (217b) and part of a solid part of a protrusion structure (217a) of a microcell of a device according to the second embodiment, wherein edge 904, which is formed by the solid part of the protrusion (217a) and the microcell bottom inside surface (211) at the protrusion structure well is not filleted. FIG. 16B illustrates a side view of part of a protrusion structure well (217b) and part of a solid part of a protrusion structure (217a) of a microcell of a device according to the second embodiment, wherein edge 905, which is formed by the solid part of the protrusion structure (217a) and the microcell bottom inside surface (211) at the protrusion structure well is filleted. In this example, the radius of the fillet of edge 905 is 20 micrometers. FIGS. 16A and 16B show a series of linear segments in the protrusion structure well. Each linear segment represents an electrophoretic particle; the length of each linear segment represents the velocity of the corresponding electrophoretic particle as estimated by the model; in fact, one endpoint of each linear segment represents an initial position of an electrophoretic particle (time=0 s) and the other end the linear segment represents the position of the same electrophoretic particle after 2 seconds (time=2 s). The study demonstrated that, under the influence of an electric field, there is a three-fold increase in the velocity of the electrophoretic particles near the bottom of the protrusion structure well (217b) of the device that has the filleted edge 905, as illustrated in FIG. 16B, in comparison to the velocity of the electrophoretic particles near the bottom of the protrusion structure well (217b) of the device that does not have the filleted edge, as illustrated in FIG. 16A.

Improvements in the velocity of the electrophoretic particles can be achieved by having a filleted edge (i) at the first edge, where the microcell wall inside surface 213 meets the exposed microcell bottom inside surface 211a at the channel, and/or (ii) at the second edge, where the protrusion structure 217 meets the exposed microcell bottom inside surface 211a at the channel.

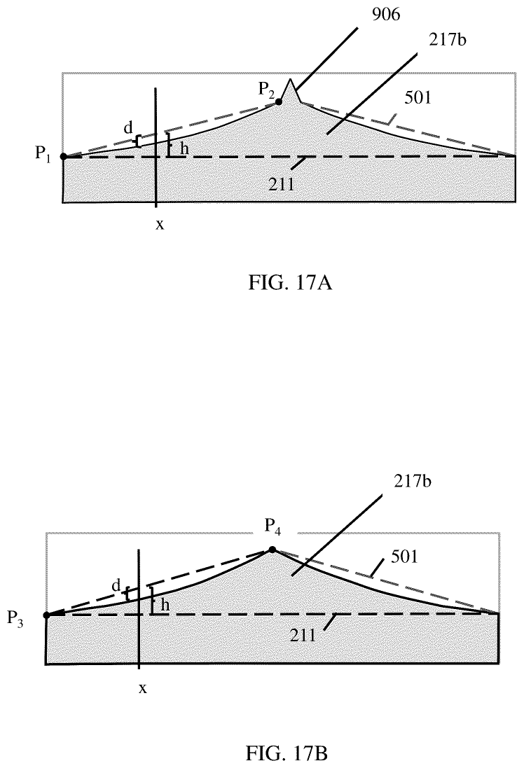

As disclosed above, the protrusion structure of a microcell of a variable light transmission device of the first embodiment or the solid part of the protrusion structure of a microcell of a variable light transmission device of the second embodiment may have a steepled part. In the case of a protrusion structure or a solid part of a protrusion structure having a steepled part, the protrusion structures of the corresponding microcells are called steepled protrusion structures. The steepled part provides improvements in the electrophoretic particle velocities. FIG. 17A illustrates part of a solid part of protrusion structure (217a) of a microcell of a device according to the second embodiment having a steepled part (906). In this example, the solid part of the protrusion structure comprises a cone on a concave conical frustum, wherein the cone is the steepled part (906). The slope of the cone is larger than the second slope of the concave conical frustum. The concave conical frustum has a curved surface, the curvature of which can be defined by parameters d and h, both of which are functions of the lateral position x. For each lateral position, there are values of d and h, wherein parameter h is the distance between the large base of the concave conical frustum 502 and secant line 501. Secant line 501 is linear segment P₁P₂, wherein P₁ is a point on the large base of the concave conical frustum and P₂ is a point on the small point on the small base of the concave conical frustum, both P₁ and P₂ being on a plane that is vertical to the plane of the microcell bottom inside layer 211. Parameter d is the portion of linear segment h that is between the protrusion side surface and secant line 501. If d is equal to zero, there is no curvature (concavity). Concavity exists when d is larger than zero. FIG. 17B illustrates part of a solid part of protrusion structure (217a) of a microcell of a device according to the second embodiment that does not have a steepled part (906). In this example, the solid part of the protrusion structure comprises a concave cone. The concave cone has a curved surface, the curvature of which can be defined by parameters d and h, both of which are functions of the lateral position x. For each lateral position, there are values of d and h, wherein parameter h is the distance between the base of the concave conical frustum 502 and secant line 501. Secant line 501 is linear segment P₃P₄, wherein P₃ is a point on the base of the concave cone and P₄ is a point on the apex of the concave cone, both P₃ and P₄ being on a plane that is vertical to the plane of the microcell bottom inside layer 211. Parameter d is the portion of linear segment h that is between the protrusion side surface and secant line 501. Finite element modeling studies using the COMSOL multi-physics tool showed that optimum performance is observed when the value of d for each lateral position x is between zero and the maximum of (1) h/2 and (2) ⅓ of the distance between the large base and the small base of the concave conical frustum for the device of FIG. 17A or the distance between the apex of the concave cone and the base of the concave cone for the device of FIG. 17B.

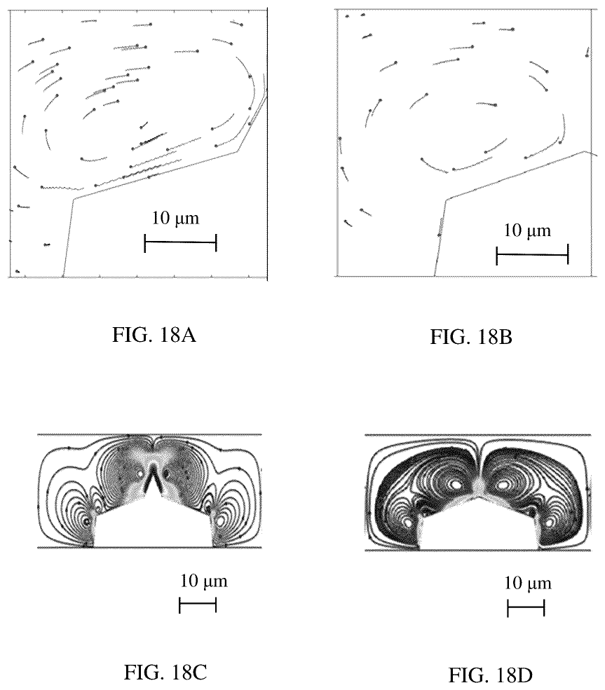

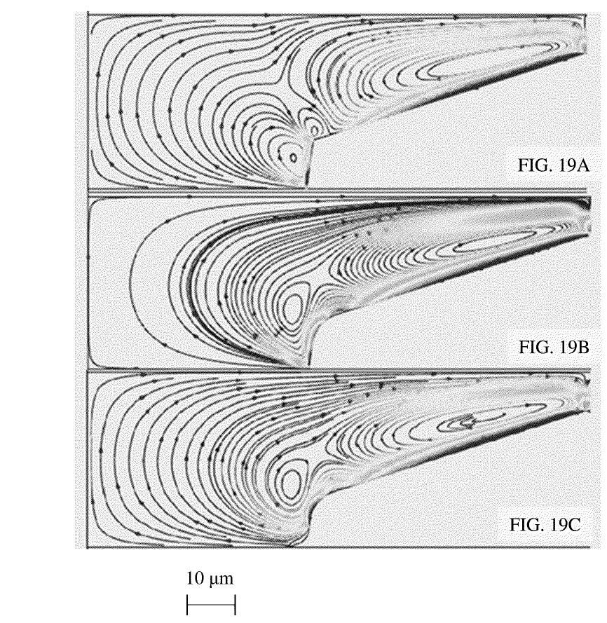

The effect of a steepled part in the solid part of protrusion structure in the microcell of a device according to the second embodiment was evaluated by finite element modeling study, using the COMSOL multi-physics tool. For this study, Device Y was selected having a solid part of a protrusion structure, the three-dimensional shape of which was a cone on a first conical frustum on a second conical frustum. The slope of the cone is larger than the slope of the first conical frustum and the slope of the first conical frustum is smaller that the slope of the second conical frustum. Modeling results of Device Y were compared with the corresponding results of Control Device X. Control Device X has a solid part of a protrusion structure, the three-dimensional shape of which was a cone on a conical frustum, the slope of the cone being smaller than the slope of the conical frustum. Results of the modeling studies for Device Y are shown in FIGS. 18A and 18C, whereas the modeling studies for Control Device X are shown in FIGS. 18B and 18D. FIGS. 18A (for Device Y) and 16B (for Control Device X) show a series of linear segments in the protrusion structure well. Each linear segment represents an electrophoretic particle; the length of each linear segment represents the velocity of the corresponding electrophoretic particle as estimated by the model; in fact, one endpoint of each linear segment represents an initial position of an electrophoretic particle (time=0 s) and the other end the linear segment represents the position of the same electrophoretic particle after 2 seconds (time=2 s). The study demonstrated that, under the influence of an electric field, the velocity of electrophoretic particles of Device Y is higher than the velocity of electrophoretic particles of Control Device X, and there are more electrophoretic particles in the case of Device Y that are mobile. In addition, a finite element modeling study using the COMSOL multi-physics tool was performed to determine the flow of the liquid electrophoretic medium in both Device Y and Control Device X. The results of the study are shown in FIGS. 18C and 18D respectively. They show that there is increased fluid acceleration near the steeple part of the solid part of the protrusion structure of Device Y in comparison to the fluid acceleration near the apex of the solid part of the protrusion structure of Control Device X, indicating that the closed optical state would be achieved more effectively in Device Y.

Finally, finite element modeling study using the COMSOL multi-physics tool was performed for three devices (Device A, Device B, and Device C) according to the second embodiment (microcells with a protrusion structure having a protrusion structure well). The three-dimensional shape of the solid part of protrusion structure well of Device A is a cone on a conical frustum (no filleted edge); the three-dimensional shape of the solid part of protrusion structure well of Device B is a cone on a convex conical frustum (filleted edge of curvature radius of 10 micrometers is formed by the curved surface of cone and curved surface of convex conical frustum; no filleted edge between the microcell bottom inside surface and solid part of protrusion base); the three-dimensional shape of the solid part of protrusion structure well of Device C is a cone on a convex conical frustum on a concave cone (filleted edge of curvature radius of 10 micrometers is formed by curved surface of cone and curved surface of convex conical frustum and filleted edge of curvature radius of 10 micrometers is formed between the microcell bottom inside surface and solid part of protrusion base). Upon application of an electric field, there are seven circular flow lines in the protrusion structure well near the microcell bottom inside surface for Device A. These circular flow lines are reduced to two for Devices B and C, which indicate that, in the cases of Devices B and C, the electrophoretic particles, which are initially located inside the protrusion structure well (at the closed optical state) will move more easily away from the protrusion structure well and towards the microcell opening than in the case of Device A.

### Clauses

Clause 1: A variable light transmission device (200) comprising:
a first light transmissive electrode layer (202);
a second light transmissive electrode layer (207); and
a microcell layer (203), the microcell layer (203) being disposed between the first light transmissive electrode layer (202) and the second light transmissive electrode layer (207), the microcell layer (203) comprising a plurality of microcells (204) and a sealing layer (206), each microcell of the plurality of microcells (204) including an electrophoretic medium (209), the electrophoretic medium (209) comprising electrically charged pigment particles (223) and a non-polar liquid, each microcell of the plurality of microcells (204) having a microcell opening (205), the sealing layer (206) spanning the microcell openings (205) of the plurality of microcells (204);
the sealing layer (206) of each microcell having an upper surface and a lower surface, the lower surface being in contact with the electrophoretic medium (209), the upper surface being in contact (i) with the first light transmissive electrode layer (202) or (ii) with an adhesive layer, the adhesive layer being disposed between the first light transmissive electrode layer (202) and the upper surface of the sealing layer (206);
each microcell of the plurality of microcells (204) comprising a microcell bottom layer (210), a protrusion structure (217), a microcell wall (212), and a channel (215), the microcell bottom layer (210) having a microcell bottom inside surface (211), the microcell bottom inside surface (211) comprising an exposed microcell bottom inside surface (211a) and an unexposed microcell bottom inside surface (211b);
the protrusion structure (217) having a protrusion side surface (221), a protrusion base (218), a protrusion apex (219), a protrusion height (220), and, optionally, a protrusion structure well (217b) in which case the protrusion structure (217) is a combination of a solid part of the protrusion structure (217a) and the protrusion structure well (217b);
the protrusion structure well (217b) having a volume that is filled with electrophoretic medium (209), the protrusion structure well (217b) being a three-dimensional shape consisting of one geometric solid or a combination of two or more geometric solids, the one geometric solid and each geometric solid of the combination of two or more geometric solids of the three-dimensional shape of the protrusion structure well (217b) being selected from the group consisting of a cone, a concave cone, a convex cone, a conical frustum, a concave conical frustum, a convex conical frustum, and a cylinder, the cone, the concave cone, and the convex cone having a base, an apex, and a slope, the conical frustum having a large base, a small base, and a slope, the concave conical frustum and the convex conical frustum having a large base, a small base, a first slope, and a second slope, and the cylinder having a first base and a second base;
the protrusion side surface, in the case where the protrusion structure has a protrusion structure well (217b), being a surface of the solid part of the protrusion structure (217a), not including the protrusion apex (219), that is in contact with the electrophoretic medium (209), the protrusion side surface consisting of a protrusion inside surface (222b) and a protrusion outside surface (222a), the protrusion inside surface (222b) being in contact with the protrusion structure well (217b), the protrusion outside surface (222a) being the protrusion side surface without the protrusion inside surface (222b), the protrusion side surface (221), in the case where the protrusion structure (217) does not have a protrusion structure well, being a surface of the protrusion structure (217), not including the protrusion apex (219), that is in contact with the electrophoretic medium (209);
the protrusion base (218) being a surface of the protrusion structure (217) that is in contact with the microcell bottom inside surface (211);
the protrusion apex (219) being a point or a set of points of the protrusion structure (217) having shorter distance from the microcell opening (205) than all other points of the protrusion structure (217), the protrusion height (220) being the distance between the protrusion base (218) and the protrusion apex (219);
the protrusion structure well (217b) having a protrusion structure well base (218b), the protrusion structure well base (218b) being a surface of the three-dimensional shape of the protrusion structure well (217b) that is in contact with the microcell bottom inside surface (211), the three-dimensional shape of the protrusion structure well (217b) being defined by a space between (i) a plane that is parallel to the plane of the protrusion base (218) and includes the protrusion apex (219), (ii) the protrusion inside surface (222b), and (iii) the microcell bottom inside surface (211);
the microcell wall (212) having a microcell inside wall surface (213) and a microcell wall upper surface (214), the microcell inside wall surface (213) being a surface of the microcell wall (212) that is in contact with the electrophoretic medium (209), the microcell wall upper surface (214) being the surface of the microcell wall (212) that is in contact with the sealing layer (206);
the channel (215) having a channel height (216h), a channel base, a channel base width, an inner base perimeter (224), and an outer base perimeter (225), the channel height (216h) being 50% of the protrusion height (220), the inner base perimeter (224) being the intersection of the microcell wall (212) and the exposed microcell bottom inside surface (211a), the outer base perimeter (225) being the intersection of the protrusion base (218) and the exposed microcell bottom inside surface (211a), the channel base width being the smallest distance between a point in the inner base perimeter (224) and a point in the outer base perimeter (225);
in the case where the protrusion structure (217) does not has a protrusion structure well (217b), the channel (215) is a three-dimensional shape that is defined by a space between (i) the exposed microcell bottom inside surface (211a), (ii) the microcell wall inside surface (213), (iii) a plane that is parallel to the microcell bottom inside surface (211), the plane having a distance from the microcell bottom inside surface (211) equal to the channel height (216h), and (iv) the protrusion side surface (221); in the case where the protrusion structure (217) has a protrusion structure well (217b), the channel (215) is a three-dimensional shape that is defined by a space between (i) the exposed microcell bottom inside surface (211a), (ii) the microcell wall inside surface (213), (iii) a plane that is parallel to the microcell bottom inside surface (211), the plane having a distance from the microcell bottom inside surface (211) equal to the channel height (216h), and (iv) the protrusion outside surface (222a); the channel (215) comprising a first edge (226) and a second edge (227), the first edge (226) being formed by the microcell wall inside surface (213) and the microcell bottom inside surface (211), the second edge (227) being formed by the microcell bottom inside surface (211) and the protrusion side surface (221), the first edge (226), the second edge (227), or both the first edge (226) and second edge (227) being filleted;
wherein application of a first electric field via a first waveform between the first light transmissive electrode layer (202) and the second light transmissive electrode layer (207) of the variable light transmission device the protrusion structure of which does not have a protrusion structure well, causes movement of the electrically charged pigment particles (223) towards the channel (215), or application of a first electric field via a first waveform between the first light transmissive electrode layer (202) and the second light transmissive electrode layer (207) of the variable light transmission device the protrusion structure of which has a protrusion structure well, cause movement of the electrically charged pigment particles (223) towards the channel (215) and the protrusion structure well (217b), resulting in switching of the variable light transmission device (200) to an open optical state; and
wherein application of a second electric field via a second waveform between the first light transmissive electrode layer (202) and the second light transmissive electrode layer (207) causes a movement of the electrically charged pigment particles (223) towards the first light transmissive electrode layer (202), wherein the closed optical state has lower percent transparency than the open optical state.

Clause 2: The variable light transmission device of clause 1, wherein the protrusion structure (217) does not have a protrusion structure well, wherein the protrusion structure (217) is a three-dimensional shape consisting of one geometric solid or a combination of two or more geometric solids, the one geometric solid and each geometric solid of the combination of the two or more geometric solids of the three-dimensional shape of the protrusion structure (217) being selected from the group consisting of a cone, a concave cone, a conical frustum, a concave conical frustum, a convex conical frustum, and a cylinder, the cone and the concave cone having a base, an apex, and a slope, the conical frustum having a large base, a small base, and a slope, the concave conical frustum and the convex conical frustum having a large base, a small base, a first slope, and a second slope, and the cylinder having a first base and a second base.

Clause 3: The variable light transmission device of clause 2, wherein the three-dimensional shape of the protrusion structure (217) consists of one geometric solid, the one geometric solid is a cone or a concave cone, the apex of the cone or concave cone being the protrusion apex (219), and the base of the cone or concave cone being the protrusion base (218).

Clause 4: The variable light transmission device according to any one of clause 2 to clause 4, wherein the three-dimensional shape of the protrusion structure (217) consists of two, three, or four geometric solids, the protrusion structure (217) being, respectively, a first geometric solid on a second geometric solid, a first geometric solid on a second geometric solid on a third geometric solid, or a first geometric solid on a second geometric solid on a third geometric solid on a fourth geometric solid, the first geometric solid comprising the protrusion apex (219), the first geometric solid being a cone or a concave cone, and the apex of the cone or concave cone being the protrusion apex (219).

Clause 5: The variable light transmission device of clause 4, wherein the three-dimensional shape of the protrusion structure (217) is (a) a concave cone on a cylinder, the first base of the cylinder being the protrusion base (218), the second base of the cylinder being in contact with the base of the concave cone, and the apex of the concave cone being the protrusion apex (219); (b) a cone on a conical frustum, the large base of the conical frustum being the protrusion base (218), the small base of the conical frustum being in contact with the base of the cone, the apex of the cone being the protrusion apex (219), and the slope of the cone being larger than the slope of the conical frustum; (c) a concave cone on a conical frustum, the large base of the conical frustum being the protrusion base (218), the small base of the conical frustum being in contact with the base of the concave cone, and the apex of the concave cone being the protrusion apex (219); (d) a cone or a concave cone on a concave conical frustum, the large base of the concave conical frustum being the protrusion base (218), the small base of the concave conical frustum being in contact with the base of the cone or concave cone, the apex of the cone or concave cone being the protrusion apex (219); (e) a cone or a concave cone on a convex conical frustum, the large base of the convex conical frustum being the protrusion base (218), the small base of the convex conical frustum being in contact with the base of the cone or concave cone, and the apex of the cone or concave cone being the protrusion apex (219); (f) a cone or a concave cone on a convex conical frustum on a conical frustum, the large base of the conical frustum being the protrusion base (218), the small base of the conical frustum being in contact with the large base of the convex conical frustum, the small base of the convex conical frustum being in contact with the base of the cone or concave cone, the apex of the cone or concave being the protrusion apex (219), and the slope of the cone being larger than the second slope of the convex conical frustum; (g) a cone or a concave cone on a convex conical frustum on a concave conical frustum, the large base of the concave conical frustum being the protrusion base (218), the small base of the concave conical frustum being in contact with the large base of the convex conical frustum, the small base of the convex conical frustum being in contact with the base of the cone or concave cone, and the apex of the cone or concave cone being the protrusion apex (219); (h) a cone on a first conical frustum on a second conical frustum, the large base of the second conical frustum being the protrusion base (218), the small base of the second conical frustum being in contact with the large base of the first conical frustum, the small base of the first conical frustum being in contact with the base of the cone, the apex of the cone being the protrusion apex (219), and the slope of the first conical frustum being smaller than the slope of the cone; (i) a concave cone on a first conical frustum on a second conical frustum, the large base of the second conical frustum being the protrusion base (218), the small base of the second conical frustum being in contact with the large base of the first conical frustum, the small base of the first conical frustum being in contact with the base of the concave cone, and the apex of the concave cone being the protrusion apex (219); (j) a cone on a conical frustum on a concave conical frustum, the large base of the concave conical frustum being the protrusion base (218), the small base of the concave conical frustum being in contact with the large base of the conical frustum, the small base of the conical frustum being in contact with the base of the cone, the apex of the cone being the protrusion apex (219), and the slope of the conical frustum being smaller than the slope of the cone; (k) a cone or a concave cone on a concave conical frustum on a convex conical frustum, the large base of the convex conical frustum being the protrusion base (218), the small base of the convex conical frustum being in contact with the large base of the concave conical frustum, the small base of the concave conical frustum being in contact with the base of the cone or the concave cone, and the cone apex or the concave cone apex being the protrusion apex (219); (l) a cone on a conical frustum on a concave conical frustum, the large base of the concave conical frustum being the protrusion base (218), the small base of the concave conical frustum being in contact with the large base of the conical frustum, the small base of the conical frustum being in contact with the base of the cone, the apex of the cone being the protrusion apex (219), and the slope of the cone being larger than the slope of the conical frustum; (m) a concave cone on a conical frustum on a concave conical frustum, the large base of the concave conical frustum being the protrusion base (218), the small base of the concave conical frustum being in contact with the large base of the conical frustum, the small base of the conical frustum being in contact with the base of the concave cone, and the apex of the concave cone being the protrusion apex (219); (n) a cone or a concave cone on a convex conical frustum on a concave conical frustum on a conical frustum, the large base of the conical frustum being the protrusion base (218), the small base of the conical frustum being in contact with the large base of the concave conical frustum, the small base of the concave conical frustum being in contact with the large base of the convex conical frustum, the small base of the convex conical frustum being in contact with the base of the cone or concave cone, and the apex of the cone or concave cone being the protrusion apex (219); (o) a cone or a concave cone on a convex conical frustum on a first concave conical frustum or a conical frustum, on a second concave conical frustum, the large base of the second concave conical frustum being the protrusion base (218), the small base of the second concave conical frustum being in contact with the large base of the first concave conical frustum or conical frustum, the small base of the first concave conical frustum or conical frustum being in contact with the large base of the convex conical frustum, the small base of the convex conical frustum being in contact with the base of the cone or concave cone, and the apex of the cone or concave cone being the protrusion apex (219); (p) a cone or a concave cone on a first concave conical frustum on a convex conical frustum on a second concave conical frustum, the large base of the second concave conical frustum being the protrusion base (218), the small base of the second concave conical frustum being in contact with the large base of the convex conical frustum, the small base of the convex conical frustum being in contact with the large base of the first concave conical frustum, the small base of the first concave conical frustum being in contact with the base of the cone or concave cone, and the apex of the cone or concave cone being the protrusion apex (219); (q) a cone or a concave cone on a concave conical frustum on a convex conical frustum on a conical frustum, the large base of the conical frustum being the protrusion base (218), the small base of the conical frustum being in contact with the large base of the convex conical frustum, the small base of the convex conical frustum being in contact with the large base of the concave conical frustum, the small base of the concave conical frustum being in contact with the base of the cone or concave cone, and the apex of the cone or concave cone being the protrusion apex (219); and (r) a cone or a concave cone on a concave conical frustum on a conical frustum, the large base of the conical frustum being the protrusion base (218), the small base of the conical frustum being in contact with the large base of the concave conical frustum, the small base of the concave conical frustum being in contact with base of the cone or concave cone, and the apex of the cone or concave cone being the protrusion apex (219).

Clause 6: The variable light transmission device of clause 1, wherein the protrusion structure (217) has a protrusion structure well (217b), (i) wherein, where the three-dimensional shape of the protrusion structure well (217b) consists of one geometric solid, the one geometric solid is a cylinder, a conical frustum, a convex conical frustum, a cone, or a convex cone, the first base of the cylinder, the large base of the conical frustum, the large base of the convex conical frustum, the base of the cone, or the base of the convex cone being on a plane that is parallel to the microcell bottom inside surface (211) and containing the protrusion apex (219), the second base of the cylinder, the small base of the conical frustum, the small base of the convex conical frustum, the apex of the cone, or the apex of the convex cone being in contact with the microcell bottom inside surface (211); (ii) wherein, where the three-dimensional shape of the protrusion structure well (217b) consists of a combination of two geometric solids, a first geometric solid and a second geometric solid, the first geometric solid being on the second geometric solid, the first geometric solid is a conical frustum, a convex conical frustum, or a concave conical frustum, the second geometric solid is a conical frustum, a convex conical frustum, a concave conical frustum, a cylinder, a cone, a concave cone, or a convex cone, the large base of the conical frustum, the large base of the convex conical frustum, or the large base of the concave conical frustum of the first geometric solid being on a plane that is parallel to the microcell bottom inside surface (211) and containing the protrusion apex (219), the small base of the conical frustum, the small base of the convex conical frustum, or the small base of the concave conical frustum of the first geometric solid being in contact with the large base of the conical frustum, the large base of the convex conical frustum, the large base of the concave conical frustum, the first base of the cylinder, the base of the cone, the base of the concave cone, or the base of the convex cone of the second geometric solid, the small base of the conical frustum, the small base of the convex conical frustum, the small base of the concave conical frustum, the second base of the cylinder, the apex of the cone, the apex of the concave cone, or the apex of the convex cone of the second geometric solid being in contact with the microcell bottom inside surface (211); and (iii) wherein, where the three-dimensional shape of the protrusion structure well (217b) consists of a combination of three geometric solids, a first geometric solid, a second geometric solid, and the third geometric solid, the first geometric solid being on a second geometric solid being on a third geometric solid, the first geometric solid is a conical frustum, a convex conical frustum, or a concave conical frustum, the second geometric solid is a conical frustum, a convex conical frustum, or a concave conical frustum, the third geometric solid is a conical frustum, a convex conical frustum, a concave conical frustum, a cone, a convex cone, a concave cone, or a cylinder, the large base of the conical frustum, the large base of the convex conical frustum, or the large concave conical frustum of the first geometric solid being on a plane that is parallel to the microcell bottom inside surface (211) and containing the protrusion apex (219), the small base of the conical frustum, the small base of the convex conical frustum, or the small base of the concave conical frustum of the first geometric solid being in contact with the large base of the conical frustum, the large base of the convex conical frustum, or the large base of the concave conical frustum of the second geometric solid, the small base of the conical frustum, the small base of the convex conical frustum, or the small base of the concave conical frustum of the second geometric solid being in contact with the large base of the conical frustum, the large base of the convex conical frustum, the large base of the concave conical frustum, the base of the cone, the base of the convex cone, the base of the concave cone, or the large base of the cylinder of the third geometric solid, the small base of the conical frustum, the small base of the convex conical frustum, the small base of the concave conical frustum, the apex of the cone, the apex of the convex cone, the apex of the concave cone, or the second base of the cylinder of the third geometric solid being in contact with the microcell bottom inside surface (211).

Clause 7: The variable light transmission device of according to clause 1 or clause 6, wherein the protrusion structure (217) has a protrusion structure well (217b), wherein the three-dimensional shape of the protrusion structure (217) is (a) a concave conical frustum, the large base of the concave conical frustum being the protrusion base (218) and the small base of the concave conical frustum being the protrusion apex (219); (b) a concave conical frustum on a cylinder, the first base of the cylinder being the protrusion base (218), the second base of the cylinder being in contact with the large base of the concave conical frustum, and the small base of the being the concave conical frustum being the protrusion apex (219); (c) a first conical frustum on a second conical frustum, the large base of the second conical frustum being the protrusion base (218), the small base of the second conical frustum being in contact with the large base of the first conical frustum, and the small base of the first conical frustum being the protrusion apex (219); (d) a concave conical frustum on a conical frustum, the large base of the conical frustum being the protrusion base (218), the small base of the conical frustum being in contact with the large base of the concave conical frustum, and the small base of the concave conical frustum being the protrusion apex (219); (e) a first concave conical frustum on a second concave conical frustum, the large base of the second concave conical frustum being the protrusion base (218), the small base of the second concave conical frustum being in contact with the large base of the first concave conical frustum, and the small base of the first concave conical frustum being the protrusion apex (219); (f) a conical frustum on a convex conical frustum, the large base of the convex conical frustum being the protrusion base (218), the small base of the convex conical frustum being in contact with the large base of the conical frustum, and the small base of the conical frustum being the protrusion apex (219); (g) a concave conical frustum on a convex conical frustum, the large base of the convex conical frustum being the protrusion base (218), the small base of the convex conical frustum being in contact with the large base of the concave conical frustum, and the small base of the concave conical frustum being the protrusion apex (219).

Clause 8: The variable light transmission device according to clause 1 or clause 6, wherein the protrusion structure (217) has a protrusion structure well (217b), wherein the three-dimension structure of the protrusion structure (217) consists of a first geometric solid on a second geometric solid on a third geometric solid, wherein the first geometric solid is a conical frustum or a concave conical frustum, the second geometric solid is a conical frustum, a concave conical frustum, or a convex conical frustum, the third geometric solid is a conical frustum, a concave conical frustum, or a convex conical frustum, wherein the large base of the conical frustum, a concave conical frustum, or a convex conical frustum of the third geometric solid is the protrusion base (218), wherein the small base of the conical frustum, a concave conical frustum, or a convex conical frustum of the third geometric solid is in contact with the large base of the conical frustum, a concave conical frustum, or a convex conical frustum of the second geometric solid, wherein the small base of the conical frustum, a concave conical frustum, or a convex conical frustum of the second geometric solid is in contact with the large base of the conical frustum or the concave conical frustum of the first geometric solid, and wherein the small base of the conical frustum or the concave conical frustum of the first geometric solid is the protrusion apex (219).

Clause 9: The variable light transmission device according to any one of clause 1 to clause 8, wherein each microcell of the plurality of microcells (204) has a length of from 400 micrometers to 800 micrometers and a height of from 20 micrometers to 100 micrometers, wherein the channel (215) of each microcell of the plurality of microcells (204) has a width of from 10 micrometers to 30 micrometers, and wherein the protrusion height (220) of each microcell of the plurality of microcells (204) is from 15 micrometers to 90 micrometers.

Clause 10: The variable light transmission device according to any one of clause 1 to clause 9, wherein the variable light transmission device comprises a microcell, wherein the inside wall surface (213) and the microcell bottom inside surface (211) of the microcell form an angle (φ), the angle (φ) being from 90 to 120 degrees.

Clause 11: The variable light transmission device according to any one of clause 1 to clause 10, wherein the variable light transmission device comprises (i) an adhesive layer, the adhesive layer being disposed between the first light transmissive electrode layer (202) and the sealing layer (206), (ii) a second adhesive layer, the second adhesive layer being disposed between the microcell layer (203) and the second light transmissive electrode layer (207), or (iii) both the adhesive layer and the second adhesive layer.

Clause 12: The variable light transmission device according to any one of clause 1 to clause 11, wherein the electrically charged pigment particles (223) are light absorbing.

Clause 13: The variable light transmission device according to any one of clause 1 to clause 12, wherein the variable light transmission device comprises a light blocking layer (230) disposed between the microcell wall upper surface (214) and the sealing layer (206).

Clause 14: The variable light transmission device of clause 13, wherein the light blocking layer (230) comprises light absorbing pigment.

Clause 15: The variable light transmission device of clause 14, wherein the light absorbing pigment of the light blocking layer (230) has black color.

Clause 16: The variable light transmission device according to any one of clause 13 to clause 15, wherein the light blocking layer (230) is conductive.

Clause 17: The variable light transmission device according to any one of clause 1 to clause 16, wherein the movement of the electrically charged pigment particles (223) towards the first light transmissive electrode layer (202) caused by application of the second electric field has a velocity, the velocity having a lateral component.

Clause 18: The variable light transmission device according to any one of clause 1 to clause 17, wherein the second waveform comprises at least one positive voltage and at least one negative voltage, the second waveform having a net positive or net negative impulse.

Clause 19: The variable light transmission device of clause 18, wherein the second waveform comprises an AC waveform, the AC waveform having a duty cycle of from 5% to 45%.

Clause 20: The variable light transmission device of clause 18, wherein the second waveform comprises a DC-offset waveform, which is formed by a superposition of a DC voltage component and an AC waveform.

### REFERENCE NUMBERS IS DRAWINGS

200, 500 variable light transmission device; 201 first light transmissive substrate; 202 first light transmissive electrode layer; 203 microcell layer; 204 plurality or microcells; 205 microcell opening; 206 sealing layer; 207 second light transmissive electrode layer; 208 second light transmissive substrate; 209 electrophoretic medium; 210 microcell bottom layer; 211 microcell bottom inside surface; 211a exposed microcell bottom inside surface; 211b unexposed microcell bottom inside surface; 212 microcell wall; 213 microcell wall inside surface; 214 microcell wall upper surface; 215 channel; 216h channel height; 216w channel base width; 217 protrusion structure; 217a solid part of protrusion structure; 217b protrusion structure well; 218 protrusion base; 218b protrusion structure well base; 219 protrusion apex; 220 protrusion height; 221 protrusion side surface; 222a protrusion outside surface; 222b protrusion inside surface; 223 electrically charged pigment particles; 224 inner base perimeter of channel; 225 outer base perimeter of channel; 226 first edge; 227 second edge; 230 light blocking layer; 250 first outside surface of a variable light transmission electro-optic device; 602 electric field; 901 filleted first edge; 902 filleted second edge, 903 filleted edge in protrusion inside surface; 904 not filleted edge that is formed by solid part of protrusion structure and microcell bottom inside surface at the protrusion structure well; 905 filleted edge that is formed by solid part of protrusion structure and microcell bottom inside surface at the protrusion structure well.

The invention claimed is:

1. A variable light transmission device (200) comprising:
a first light transmissive electrode layer (202);
a second light transmissive electrode layer (207); and
a microcell layer (203), the microcell layer (203) being disposed between the first light transmissive electrode layer (202) and the second light transmissive electrode layer (207), the microcell layer (203) comprising a plurality of microcells (204) and a sealing layer (206), each microcell of the plurality of microcells (204) including an electrophoretic medium (209), the electrophoretic medium (209) comprising electrically charged pigment particles (223) and a non-polar liquid, each microcell of the plurality of microcells (204) having a microcell opening (205), the sealing layer (206) spanning the microcell openings (205) of the plurality of microcells (204);
the sealing layer (206) of each microcell having an upper surface and a lower surface, the lower surface being in contact with the electrophoretic medium (209), the upper surface being in contact (i) with the first light transmissive electrode layer (202) or (ii) with an adhesive layer, the adhesive layer being disposed between the first light transmissive electrode layer (202) and the upper surface of the sealing layer (206);
each microcell of the plurality of microcells (204) comprising a microcell bottom layer (210), a protrusion structure (217), a microcell wall (212), and a channel (215), the microcell bottom layer (210) having a microcell bottom inside surface (211), the microcell bottom inside surface (211) comprising an exposed microcell bottom inside surface (211a) and an unexposed microcell bottom inside surface (211b);
the protrusion structure (217) having a protrusion side surface (221), a protrusion base (218), a protrusion apex (219), a protrusion height (220), and, optionally, a protrusion structure well (217b) in which case the protrusion structure (217) is a combination of a solid part of the protrusion structure (217a) and the protrusion structure well (217b);
the protrusion structure well (217b) having a volume that is filled with electrophoretic medium (209), the protrusion structure well (217b) having a three-dimensional shape consisting of one geometric solid or a combination of two or more geometric solids, the one geometric solid and each geometric solid of the combination of two or more geometric solids of the three-dimensional shape of the protrusion structure well (217b) being selected from the group consisting of a cone, a concave cone, a convex cone, a conical frustum, a concave conical frustum, a convex conical frustum, and a cylinder, the cone, the concave cone, and the convex cone having a base, an apex, and a slope, the conical frustum having a large base, a small base, and a slope, the concave conical frustum and the convex conical frustum having a large base, a small base, a first slope, and a second slope, and the cylinder having a first base and a second base;
the protrusion side surface, in the case where the protrusion structure has a protrusion structure well (217b), being a surface of the solid part of the protrusion structure (217a), not including the protrusion apex (219), that is in contact with the electrophoretic medium (209), the protrusion side surface consisting of a protrusion inside surface (222b) and a protrusion outside surface (222a), the protrusion inside surface (222b) being in contact with the protrusion structure well (217b), the protrusion outside surface (222a) being the protrusion side surface without the protrusion inside surface (222b), the protrusion side surface (221), in the case where the protrusion structure (217) does not have a protrusion structure well, being a surface of the protrusion structure (217), not including the protrusion apex (219), that is in contact with the electrophoretic medium (209);
the protrusion base (218) being a surface of the protrusion structure (217) that is in contact with the microcell bottom inside surface (211);
the protrusion apex (219) being a point or a set of points of the protrusion structure (217) having shorter distance from the microcell opening (205) than all other points of the protrusion structure (217), the protrusion height (220) being the distance between the protrusion base (218) and the protrusion apex (219);
the protrusion structure well (217b) having a protrusion structure well base (218b), the protrusion structure well base (218b) being a surface of the three-dimensional shape of the protrusion structure well (217b) that is in contact with the microcell bottom inside surface (211), the three-dimensional shape of the protrusion structure well (217b) being defined by a space between (i) a plane that is parallel to the plane of the protrusion base (218) and includes the protrusion apex (219), (ii) the protrusion inside surface (222b), and (iii) the microcell bottom inside surface (211);
the microcell wall (212) having a microcell inside wall surface (213) and a microcell wall upper surface (214), the microcell inside wall surface (213) being a surface of the microcell wall (212) that is in contact with the electrophoretic medium (209), the microcell wall upper surface (214) being the surface of the microcell wall (212) that is in contact with the sealing layer (206);
the channel (215) having a channel height (216h), a channel base, a channel base width, an inner base perimeter (224), and an outer base perimeter (225), the channel height (216h) being 50% of the protrusion height (220), the inner base perimeter (224) being the intersection of the microcell wall (212) and the exposed microcell bottom inside surface (211a), the outer base perimeter (225) being the intersection of the protrusion base (218) and the exposed microcell bottom inside surface (211a), the channel base width being the smallest distance between a point in the inner base perimeter (224) and a point in the outer base perimeter (225);
in the case where the protrusion structure (217) does not has a protrusion structure well (217b), the channel (215) is a three-dimensional shape that is defined by a space between (i) the exposed microcell bottom inside surface (211a), (ii) the microcell wall inside surface (213), (iii) a plane that is parallel to the microcell bottom inside surface (211), the plane having a distance from the microcell bottom inside surface (211) equal to the channel height (216h), and (iv) the protrusion side surface (221); in the case where the protrusion structure (217) has a protrusion structure well (217b), the channel (215) is a volume that is defined by (i) the exposed microcell bottom inside surface (211a), (ii) the microcell wall inside surface (213), (iii) a plane that is parallel to the microcell bottom inside surface (211), the plane having a distance from the microcell bottom inside surface (211) equal to the channel height (216h), and (iv) the protrusion outside surface (222a); the channel (215) comprising a first edge (226) and a second edge (227), the first edge (226) being formed by the microcell wall inside surface (213) and the microcell bottom inside surface (211), the second edge (227) being formed by the microcell bottom inside surface (211) and the protrusion side surface (221), the first edge (226), the second edge (227), or both the first edge (226) and second edge (227) being filleted;
wherein application of a first electric field via a first waveform between the first light transmissive electrode layer (202) and the second light transmissive electrode layer (207) of the variable light transmission device the protrusion structure of which does not have a protrusion structure well, causes movement of the electrically charged pigment particles (223) towards the channel (215), or application of a first electric field via a first waveform between the first light transmissive electrode layer (202) and the second light transmissive electrode layer (207) of the variable light transmission device the protrusion structure of which has a protrusion structure well, cause movement of the electrically charged pigment particles (223) towards the channel (215) and the protrusion structure well (217b), resulting in switching of the variable light transmission device (200) to an open optical state; and
wherein application of a second electric field via a second waveform between the first light transmissive electrode layer (202) and the second light transmissive electrode layer (207) causes a movement of the electrically charged pigment particles (223) towards the first light transmissive electrode layer (202), wherein the closed optical state has lower percent transparency than the open optical state.

2. The variable light transmission device of claim 1, wherein the protrusion structure (217) does not have a protrusion structure well, wherein the protrusion structure (217) is a three-dimensional shape consisting of one geometric solid or a combination of two or more geometric solids, the one geometric solid and each geometric solid of the combination of the two or more geometric solids of the three-dimensional shape of the protrusion structure (217) being selected from the group consisting of a cone, a concave cone, a conical frustum, a concave conical frustum, a convex conical frustum, and a cylinder, the cone and the concave cone having a base, an apex, and a slope, the conical frustum having a large base, a small base, and a slope, the concave conical frustum and the convex conical frustum having a large base, a small base, a first slope, and a second slope, and the cylinder having a first base and a second base.

3. The variable light transmission device of claim 2, wherein the three-dimensional shape of the protrusion structure (217) consists of one geometric solid, the one geometric solid is a cone or a concave cone, the apex of the cone or concave cone being the protrusion apex (219), and the base of the cone or concave cone being the protrusion base (218).

4. The variable light transmission device of claim 2, wherein the three-dimensional shape of the protrusion structure (217) consists of two, three, or four geometric solids, the protrusion structure (217) being, respectively, a first geometric solid on a second geometric solid, a first geometric solid on a second geometric solid on a third geometric solid, or a first geometric solid on a second geometric solid on a third geometric solid on a fourth geometric solid, the first geometric solid comprising the protrusion apex (219), the first geometric solid being a cone or a concave cone, and the apex of the cone or concave cone being the protrusion apex (219).

5. The variable light transmission device of claim 4, wherein the three-dimensional shape of the protrusion structure (217) is (a) a concave cone on a cylinder, the first base of the cylinder being the protrusion base (218), the second base of the cylinder being in contact with the base of the concave cone, and the apex of the concave cone being the protrusion apex (219); (b) a cone on a conical frustum, the large base of the conical frustum being the protrusion base (218), the small base of the conical frustum being in contact with the base of the cone, the apex of the cone being the protrusion apex (219), and the slope of the cone being larger than the slope of the conical frustum; (c) a concave cone on a conical frustum, the large base of the conical frustum being the protrusion base (218), the small base of the conical frustum being in contact with the base of the concave cone, and the apex of the concave cone being the protrusion apex (219); (d) a cone or a concave cone on a concave conical frustum, the large base of the concave conical frustum being the protrusion base (218), the small base of the concave conical frustum being in contact with the base of the cone or concave cone, the apex of the cone or concave cone being the protrusion apex (219); (e) a cone or a concave cone on a convex conical frustum, the large base of the convex conical frustum being the protrusion base (218), the small base of the convex conical frustum being in contact with the base of the cone or concave cone, and the apex of the cone or concave cone being the protrusion apex (219); (f) a cone or a concave cone on a convex conical frustum on a conical frustum, the large base of the conical frustum being the protrusion base (218), the small base of the conical frustum being in contact with the large base of the convex conical frustum, the small base of the convex conical frustum being in contact with the base of the cone or concave cone, the apex of the cone or concave being the protrusion apex (219), and the slope of the cone being larger than the second slope of the convex conical frustum; (g) a cone or a concave cone on a convex conical frustum on a concave conical frustum, the large base of the concave conical frustum being the protrusion base (218), the small base of the concave conical frustum being in contact with the large base of the convex conical frustum, the small base of the convex conical frustum being in contact with the base of the cone or concave cone, and the apex of the cone or concave cone being the protrusion apex (219); (h) a cone on a first conical frustum on a second conical frustum, the large base of the second conical frustum being the protrusion base (218), the small base of the second conical frustum being in contact with the large base of the first conical frustum, the small base of the first conical frustum being in contact with the base of the cone, the apex of the cone being the protrusion apex (219), and the slope of the first conical frustum being smaller than the slope of the cone; (i) a concave cone on a first conical frustum on a second conical frustum, the large base of the second conical frustum being the protrusion base (218), the small base of the second conical frustum being in contact with the large base of the first conical frustum, the small base of the first conical frustum being in contact with the base of the concave cone, and the apex of the concave cone being the protrusion apex (219); (j) a cone on a conical frustum on a concave conical frustum, the large base of the concave conical frustum being the protrusion base (218), the small base of the concave conical frustum being in contact with the large base of the conical frustum, the small base of the conical frustum being in contact with the base of the cone, the apex of the cone being the protrusion apex (219), and the slope of the conical frustum being smaller than the slope of the cone; (k) a cone or a concave cone on a concave conical frustum on a convex conical frustum, the large base of the convex conical frustum being the protrusion base (218), the small base of the convex conical frustum being in contact with the large base of the concave conical frustum, the small base of the concave conical frustum being in contact with the base of the cone or the concave cone, and the cone apex or the concave cone apex being the protrusion apex (219); (l) a cone on a conical frustum on a concave conical frustum, the large base of the concave conical frustum being the protrusion base (218), the small base of the concave conical frustum being in contact with the large base of the conical frustum, the small base of the conical frustum being in contact with the base of the cone, the apex of the cone being the protrusion apex (219), and the slope of the cone being larger than the slope of the conical frustum; (m) a concave cone on a conical frustum on a concave conical frustum, the large base of the concave conical frustum being the protrusion base (218), the small base of the concave conical frustum being in contact with the large base of the conical frustum, the small base of the conical frustum being in contact with the base of the concave cone, and the apex of the concave cone being the protrusion apex (219); (n) a cone or a concave cone on a convex conical frustum on a concave conical frustum on a conical frustum, the large base of the conical frustum being the protrusion base (218), the small base of the conical frustum being in contact with the large base of the concave conical frustum, the small base of the concave conical frustum being in contact with the large base of the convex conical frustum, the small base of the convex conical frustum being in contact with the base of the cone or concave cone, and the apex of the cone or concave cone being the protrusion apex (219); (o) a cone or a concave cone on a convex conical frustum on a first concave conical frustum or a conical frustum, on a second concave conical frustum, the large base of the second concave conical frustum being the protrusion base (218), the small base of the second concave conical frustum being in contact with the large base of the first concave conical frustum or conical frustum, the small base of the first concave conical frustum or conical frustum being in contact with the large base of the convex conical frustum, the small base of the convex conical frustum being in contact with the base of the cone or concave cone, and the apex of the cone or concave cone being the protrusion apex (219); (p) a cone or a concave cone on a first concave conical frustum on a convex conical frustum on a second concave conical frustum, the large base of the second concave conical frustum being the protrusion base (218), the small base of the second concave conical frustum being in contact with the large base of the convex conical frustum, the small base of the convex conical frustum being in contact with the large base of the first concave conical frustum, the small base of the first concave conical frustum being in contact with the base of the cone or concave cone, and the apex of the cone or concave cone being the protrusion apex (219); (q) a cone or a concave cone on a concave conical frustum on a convex conical frustum on a conical frustum, the large base of the conical frustum being the protrusion base (218), the small base of the conical frustum being in contact with the large base of the convex conical frustum, the small base of the convex conical frustum being in contact with the large base of the concave conical frustum, the small base of the concave conical frustum being in contact with the base of the cone or concave cone, and the apex of the cone or concave cone being the protrusion apex (219); and (r) a cone or a concave cone on a concave conical frustum on a conical frustum, the large base of the conical frustum being the protrusion base (218), the small base of the conical frustum being in contact with the large base of the concave conical frustum, the small base of the concave conical frustum being in contact with base of the cone or concave cone, and the apex of the cone or concave cone being the protrusion apex (219).

6. The variable light transmission device of claim 1, wherein the protrusion structure (217) has a protrusion structure well (217b), (i) wherein, where the three-dimensional shape of the protrusion structure well (217b) consists of one geometric solid, the one geometric solid is a cylinder, a conical frustum, a convex conical frustum, a cone, or a convex cone, the first base of the cylinder, the large base of the conical frustum, the large base of the convex conical frustum, the base of the cone, or the base of the convex cone being on a plane that is parallel to the microcell bottom inside surface (211) and containing the protrusion apex (219), the second base of the cylinder, the small base of the conical frustum, the small base of the convex conical frustum, the apex of the cone, or the apex of the convex cone being in contact with the microcell bottom inside surface (211); (ii) wherein, where the three-dimensional shape of the protrusion structure well (217b) consists of a combination of two geometric solids, a first geometric solid and a second geometric solid, the first geometric solid being on the second geometric solid, the first geometric solid is a conical frustum, a convex conical frustum, or a concave conical frustum, the second geometric solid is a conical frustum, a convex conical frustum, a concave conical frustum, a cylinder, a cone, a concave cone, or a convex cone, the large base of the conical frustum, the large base of the convex conical frustum, or the large base of the concave conical frustum of the first geometric solid being on a plane that is parallel to the microcell bottom inside surface (211) and containing the protrusion apex (219), the small base of the conical frustum, the small base of the convex conical frustum, or the small base of the concave conical frustum of the first geometric solid being in contact with the large base of the conical frustum, the large base of the convex conical frustum, the large base of the concave conical frustum, the first base of the cylinder, the base of the cone, the base of the concave cone, or the base of the convex cone of the second geometric solid, the small base of the conical frustum, the small base of the convex conical frustum, the small base of the concave conical frustum, the second base of the cylinder, the apex of the cone, the apex of the concave cone, or the apex of the convex cone of the second geometric solid being in contact with the microcell bottom inside surface (211); and (iii) wherein, where the three-dimensional shape of the protrusion structure well (217b) consists of a combination of three geometric solids, a first geometric solid, a second geometric solid, and the third geometric solid, the first geometric solid being on a second geometric solid being on a third geometric solid, the first geometric solid is a conical frustum, a convex conical frustum, or a concave conical frustum, the second geometric solid is a conical frustum, a convex conical frustum, or a concave conical frustum, the third geometric solid is a conical frustum, a convex conical frustum, a concave conical frustum, a cone, a convex cone, a concave cone, or a cylinder, the large base of the conical frustum, the large base of the convex conical frustum, or the large concave conical frustum of the first geometric solid being on a plane that is parallel to the microcell bottom inside surface (211) and containing the protrusion apex (219), the small base of the conical frustum, the small base of the convex conical frustum, or the small base of the concave conical frustum of the first geometric solid being in contact with the large base of the conical frustum, the large base of the convex conical frustum, or the large base of the concave conical frustum of the second geometric solid, the small base of the conical frustum, the small base of the convex conical frustum, or the small base of the concave conical frustum of the second geometric solid being in contact with the large base of the conical frustum, the large base of the convex conical frustum, the large base of the concave conical frustum, the base of the cone, the base of the convex cone, the base of the concave cone, or the large base of the cylinder of the third geometric solid, the small base of the conical frustum, the small base of the convex conical frustum, the small base of the concave conical frustum, the apex of the cone, the apex of the convex cone, the apex of the concave cone, or the second base of the cylinder of the third geometric solid being in contact with the microcell bottom inside surface (211).

7. The variable light transmission device of claim 1, wherein the protrusion structure (217) has a protrusion structure well (217b), wherein the three-dimensional shape of the protrusion structure (217) is (a) a concave conical frustum, the large base of the concave conical frustum being the protrusion base (218) and the small base of the concave conical frustum being the protrusion apex (219); (b) a concave conical frustum on a cylinder, the first base of the cylinder being the protrusion base (218), the second base of the cylinder being in contact with the large base of the concave conical frustum, and the small base of the being the concave conical frustum being the protrusion apex (219); (c) a first conical frustum on a second conical frustum, the large base of the second conical frustum being the protrusion base (218), the small base of the second conical frustum being in contact with the large base of the first conical frustum, and the small base of the first conical frustum being the protrusion apex (219); (d) a concave conical frustum on a conical frustum, the large base of the conical frustum being the protrusion base (218), the small base of the conical frustum being in contact with the large base of the concave conical frustum, and the small base of the concave conical frustum being the protrusion apex (219); (e) a first concave conical frustum on a second concave conical frustum, the large base of the second concave conical frustum being the protrusion base (218), the small base of the second concave conical frustum being in contact with the large base of the first concave conical frustum, and the small base of the first concave conical frustum being the protrusion apex (219); (f) a conical frustum on a convex conical frustum, the large base of the convex conical frustum being the protrusion base (218), the small base of the convex conical frustum being in contact with the large base of the conical frustum, and the small base of the conical frustum being the protrusion apex (219); (g) a concave conical frustum on a convex conical frustum, the large base of the convex conical frustum being the protrusion base (218), the small base of the convex conical frustum being in contact with the large base of the concave conical frustum, and the small base of the concave conical frustum being the protrusion apex (219).

8. The variable light transmission device of claim 1, wherein the protrusion structure (217) has a protrusion structure well (217b), wherein the three-dimension structure of the protrusion structure (217) consists of a first geometric solid on a second geometric solid on a third geometric solid, wherein the first geometric solid is a conical frustum or a concave conical frustum, the second geometric solid is a conical frustum, a concave conical frustum, or a convex conical frustum, the third geometric solid is a conical frustum, a concave conical frustum, or a convex conical frustum, wherein the large base of the conical frustum, a concave conical frustum, or a convex conical frustum of the third geometric solid is the protrusion base (218), wherein the small base of the conical frustum, a concave conical frustum, or a convex conical frustum of the third geometric solid is in contact with the large base of the conical frustum, a concave conical frustum, or a convex conical frustum of the second geometric solid, wherein the small base of the conical frustum, a concave conical frustum, or a convex conical frustum of the second geometric solid is in contact with the large base of the conical frustum or the concave conical frustum of the first geometric solid, and wherein the small base of the conical frustum or the concave conical frustum of the first geometric solid is the protrusion apex (219).

9. The variable light transmission device of claim 1, wherein each microcell of the plurality of microcells (204) has a length of from 400 micrometers to 800 micrometers and a height of from 20 micrometers to 100 micrometers, wherein the channel (215) of each microcell of the plurality of microcells (204) has a width of from 10 micrometers to 30 micrometers, and wherein the protrusion height (220) of each microcell of the plurality of microcells (204) is from 15 micrometers to 90 micrometers.

10. The variable light transmission device of claim 1, wherein the variable light transmission device comprises a microcell, wherein the inside wall surface (213) and the microcell bottom inside surface (211) of the microcell form an angle (φ), the angle (φ) being from 90 to 120 degrees.

11. The variable light transmission device of claim 1, wherein the variable light transmission device comprises (i) an adhesive layer, the adhesive layer being disposed between the first light transmissive electrode layer (202) and the sealing layer (206), (ii) a second adhesive layer, the second adhesive layer being disposed between the microcell layer (203) and the second light transmissive electrode layer (207), or (iii) both the adhesive layer and the second adhesive layer.

12. The variable light transmission device of claim 1, wherein the electrically charged pigment particles (223) are light absorbing.

13. The variable light transmission device of claim 1, wherein the variable light transmission device comprises a light blocking layer (230) disposed between the microcell wall upper surface (214) and the sealing layer (206).

14. The variable light transmission device of claim 13, wherein the light blocking layer (230) comprises light absorbing pigment.

15. The variable light transmission device of claim 14, wherein the light absorbing pigment of the light blocking layer (230) has black color.

16. The variable light transmission device of claim 13, wherein the light blocking layer (230) is conductive.

17. The variable light transmission device of claim 1, wherein the movement of the electrically charged pigment particles (223) towards the first light transmissive electrode layer (202) caused by application of the second electric field has a velocity, the velocity having a lateral component.

18. The variable light transmission device of claim 1, wherein the second waveform comprises at least one positive voltage and at least one negative voltage, the second waveform having a net positive or net negative impulse.

19. The variable light transmission device of claim 18, wherein the second waveform comprises an AC waveform, the AC waveform having a duty cycle of from 5% to 45%.

20. The variable light transmission device of claim 18, wherein the second waveform comprises a DC-offset waveform, which is formed by a superposition of a DC voltage component and an AC waveform.
